(19) United States
(12) Patent Application Publication
(10) Pub. No.: US 2004/0191629 A1
(43) Pub. Date: Sep. 30, 2004

(54) Positive electrode, non-aqueous electrolyte secondary battery, and method of manufacturing the same

(75) Inventors: Masaharu Itaya, Kobe-shi (JP); Masahide Miyake, Kobe-shi (JP); Masahisa Fujimoto, Osaka (JP)

Correspondence Address: McDERMOTT, WILL & EMERY, 600 13th Street, N.W., Washington, DC, 20005-3096, US

(73) Assignee: SANYO ELECTRIC CO., LTD.

(21) Appl. No.: 10/807,148

(22) Filed: Mar. 24, 2004

(30) Foreign Application Priority Data
Mar. 26, 2003 (JP) 2003-085138
Mar. 27, 2003 (JP) 2003-089077
Dec. 4, 2003 (JP) 2003-405837
Mar. 15, 2004 (JP) 2004-073577

(51) Int. Cl. H01M 4/58; H01M 10/40

(52) U.S. Cl. 429/231.95; 429/218.1; 429/220; 429/329; 429/337; 429/330; 429/338

(57) ABSTRACT

A non-aqueous electrolyte secondary battery comprises a positive electrode including elemental sulfur, a negative electrode including silicon that stores lithium, and a non-aqueous electrolyte including a room temperature molten salt having a melting point of not higher than 60° C. The non-aqueous electrolyte may further include at least one type of solvent selected from cyclic ether, chain ether, and fluorinated carbonate. The non-aqueous electrolyte may include a reduction product of elemental sulfur. The positive electrode has a positive electrode active material made of a mixture of elemental sulfur, a conductive agent, and a binder. The electrode having a positive electrode active material is processed under reduced-pressure while immersed in the non-aqueous electrolyte. A pressure during the reduced-pressure process is preferably not higher than 28000 Pa (−55 cmHg with respect to atmospheric pressure).

### BACKGROUND OF THE INVENTION

1. Field of the Invention

The present invention relates to a positive electrode, non-aqueous electrolyte secondary battery comprising the positive electrode, and method of manufacturing the same.

2. Description of the Background Art

In recent years, as one of the secondary batteries having high power and high energy density, non-aqueous electrolyte secondary batteries with high electromotive forces have been made available in which the oxidation and reduction of lithium using non-aqueous electrolytes is utilized.

The currently practical lithium secondary batteries have lithium cobaltate (LiCoO₂) or lithium manganate (LiMn₂O₄) as positive electrode materials, and carbon materials as negative electrode materials. In addition, these batteries have non-aqueous electrolytes including electrolyte salts of lithium salts, such as LiBF₄ and LiPF₆, dissolved in organic solvents of ethylene carbonate, diethyl carbonate, or the like.

However, portable equipment requires secondary batteries having longer duration, and hence further increased capacity and energy density of lithium secondary batteries are required.

As a negative electrode material capable of storage and release of lithium while exhibiting high capacity, the use of a silicon thin film formed by being deposited on a negative electrode current collector has been proposed (refer to JP-2001-266851-A and JP-2002-83594-A.) This negative electrode material allows a negative electrode capacity of at least 3000 to 4000 mAh/g.

However, for the preparation of a lithium secondary battery having the silicon material as a negative electrode and lithium cobaltate as a positive electrode, it is required to considerably increase the thickness of the positive electrode active material layer in order to balance the positive and negative electrode capacities. This may make it difficult for the electrolyte to penetrate into the positive electrode active material layer during a manufacturing process, and may further cause a shortage of the electrolyte in the positive electrode active material layer during charge-discharge cycles, resulting in deterioration of the charge-discharge cycle characteristics. For this reason, there exits a need for the development of positive electrode materials having a high electrode capacity balanced with the high negative electrode capacity.

In recent years, the use of an organic disulfide compound, such as DMCT (2,5-dimercapto-1,3,4-thiadiazole), as a positive electrode material for achieving high capacity and high energy density has been proposed. However, the organic disulfide compound used as a positive electrode material react reversibly with lithium only at elevated temperatures of 60° C. or higher. Therefore, the use of organic disulfide compound in general non-aqueous electrolyte secondary batteries has been difficult.

Moreover, in recent years, a secondary battery has been proposed capable of the charge-discharge reaction at room temperature using a positive electrode material obtained from the above-mentioned organic disulf ide compound, such as DMcT, mixed with a conductive polymer, such as polyaniline (refer to JP-H4-267073-A and JP-H8-115724-A.)

In the case of the above-mentioned positive electrode active material using the organic disulf ide compound, however, the disulfide bonds are involved with the charge-discharge reaction, and other parts including carbon atoms and hydrogen atoms do not contribute to the reaction. Therefore, it has been difficult to further increase a capacity per weight.

### SUMMARY OF THE INVENTION

An object of the present invention is to provide a non-aqueous electrolyte secondary battery having increased capacity and energy density.

Another object of the present invention is to provide a method of manufacturing a positive electrode having increased energy density by the use of elemental sulfur and a non-aqueous electrolyte secondary battery comprising the same.

Still another object of the present invention is to provide a positive electrode and a non-aqueous electrolyte secondary battery having increased energy densities by the use of elemental sulfur.

A non-aqueous electrolyte secondary battery according to one aspect of the present invention comprises a positive electrode, a negative electrode, and a non-aqueous electrolyte, the positive electrode including elemental sulfur, the negative electrode including silicon that stores lithium.

In the non-aqueous electrolyte secondary battery according to the present invention, the combination of the positive electrode including elemental sulfur and the negative electrode including silicon that stores lithium enables the elemental sulfur in the positive electrode and the silicon in the negative electrode to react reversibly with lithium at relatively low temperatures. In this case, the use of silicon that stores lithium can result in increased negative electrode capacity. Moreover, the use of elemental sulfur in the positive electrode enables increased capacity per unit weight, compared with that obtained using an organic disulfide compound. Accordingly, the negative electrode capacity and positive electrode capacity can be easily balanced, so that increased capacity and energy density can be realized.

The non-aqueous electrolyte may include a room temperature molten salt having a melting point of not higher than 60° C. In this case, the reversible reaction of the silicon in the negative electrode and the elemental sulfur in the positive electrode with lithium can be easily carried out also at room temperature, so as to facilitate the charging/discharging reaction at room temperature. Room temperature molten salts having melting points of not higher than 60° C. are liquids containing only ions, having fire-resistance and no vapor pressure, and therefore, they are not decomposed or burned even at the time of abnormal operations, such as overcharging, and can be safely used without the provision of a protection circuit or the like.

The room temperature molten salt may include at least one type selected from the group consisting of trimethylpropylammonium bis(trifluoromethylsulfonyl)imide ((CH₃)₃N⁺(C₃H₇)N⁻(SO₂CF₃)₂), trimethyloctylammonium bis(trifluoromethylsulfonyl)imide ((CH₃)₃N⁺(C₈H₁₇)N⁻(SO₂CF₃)₂), trimethylallylammonium bis(trifluoromethylsulfonyl)imide ((CH₃)₃N⁺(Allyl)N⁻(SO₂CF₃)₂, trimethylhexylammonium bis(trifluoromethylsulfonyl)imide ((CH₃)₃N⁺(C₆H₁₃)N⁻(SO₂CF₃)₂), trimethylethylammonium 2,2,2-trifluoro-N-(trifluoromethylsulfonyl)acetamide ((CH₃)₃N⁺(C₂H₅)(CF₃CO)N⁻(SO₂CF₃)), trimethylallylammonium 2,2,2-trifluoro-N-(trifluoromethylsulfonyl)acetamide ((CH₃)₃N⁺(Allyl)(CF₃CO)N⁻(SO₂CF₃)), trimethylpropylammonium 2,2,2-trifluoro-N-(trifluoromethylsulfonyl)acetamide ((CH₃)₃N⁺(C₃H₇)(CF₃CO)N⁻(SO₂CF₃)), tetraethylammonium 2,2,2-trifluoro-N-(trifluoromethylsulfonyl)acetamide ((C₂H₅)₄N⁺(CF₃CO)N⁻(SO₂CF₃)), triethylmethylammonium 2,2,2-trifluoro-N-(trifluoromethylsulfonyl)acetamide ((C₂H₅)₃N⁺(CH₃)(CF₃CO)N⁻(SO₂CF₃)), 1-ethyl-3-methylimidazolium bis(pentafluoroethylsulfonyl)imide ((C₂H₅)(C₃H₃N₂)⁺(CH₃)N⁻(SO₂C₂F₅) ₂), 1-ethyl-3-methylimidazolium bis(trifluoromethylsulfonyl)imide ((C₂H₅)(C₃H₃N₂)⁺(CH₃)N⁻(SO₂CF₃)₂), 1-ethyl-3-methylimidazolium tetrafluoroborate ((C₂H₅)(C₃H₃N₂)⁺(CH₃)BF₄⁻), and 1-ethyl-3-methylimidazolium pentafluoroborate ((C₂H₅)(C₃H₃N₂)⁺(CH₃)PF₆⁻).

Preferably, the room temperature molten salt includes at least one type selected from the group consisting of trimethylpropylammonium bis(trifluoromethylsulfonyl)imide, trimethylhexylammonium bis(trifluoromethylsulfonyl)imide, and triethylmethylammonium 2,2,2-trifluoro-N-(trifluoromethylsulfonyl)acetamide.

The non-aqueous electrolyte may include a quaternary ammonium salt. In this case, the reversible reaction of the silicon in the negative electrode and the elemental sulfur in the positive electrode with lithium can be easily carried out also at room temperature, so as to facilitate the charging/discharging reaction at room temperature.

The quaternary ammonium salt may include at least one type selected from the group consisting of trimethylpropylammonium bis(trifluoromethylsulfonyl)imide, trimethyloctylammonium bis(trifluoromethylsulfonyl)imide, trimethylallylammonium bis(trifluoromethylsulfonyl)imide, trimethylhexylammonium bis(trifluoromethylsulfonyl)imide, trimethylethylammonium 2,2,2-trifluoro-N-(trifluoromethylsulfonyl)acetamide, trimethylallylammonium 2,2,2-trifluoro-N-(trifluoromethylsulfonyl)acetamide, trimethylpropylammonium 2,2,2-trifluoro-N-(trifluoromethylsulfonyl)acetamide, tetraethylammonium 2,2,2-trifluoro-N-(trifluoromethylsulfonyl)acetamide, triethylmethylammonium 2,2,2-trifluoro-N-(trifluoromethylsulfonyl)acetamide, tetramethylammonium tetrafluoroborate, tetramethylammonium hexafluorophosphate, tetraethylammonium tetrafluoroborate, and tetraethylammonium hexafluorophosphate.

Preferably, the quaternary ammonium salt includes at least one type selected from the group consisting of trimethylpropylammonium bis(trifluoromethylsulfonyl)imide, trimethylhexylammonium bis(trifluoromethylsulfonyl)imide, and triethylmethylammonium 2,2,2-trifluoro-N-(trifluoromethylsulfonyl)acetamide.

The non-aqueous electrolyte may further include at least one type of solvent selected from the group consisting of cyclic ether, chain ether, and fluorinated carbonate. In this case, the reversible reaction of the silicon in the negative electrode and the elemental sulfur in the positive electrode with lithium can be more easily carried out also at room temperature, so as to further facilitate the charging/discharging reaction at room temperature.

The cyclic ether may include at least one type selected from the group consisting of 1,3-dioxolane, 2-methyl-1,3-dioxolane, 4-methyl-1,3-dioxolane, tetrahydrofuran, 2-methyl tetrahydrofuran, propylene oxide, 1,2-butylene oxide, 1,4-dioxiane, 1,3,5-trioxane, furan, 2-methy furan, 1,8-cineole, and crown ether; the chain ether may include at lest one type selected from the group consisting of 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether; and the fluorinated carbonate may include at least one type selected from the group consisting of trifluoropropylene carbonate, tetrafluoropropylene carbonate, and fluoroethyl carbonate.

The cyclic ether preferably includes at least one type selected from the group consisting of 1,3-dioxolane and tetrahydrofuran; the chain ether preferably includes 1,2-dimethoxyethane; and the fluorinated carbonate preferably includes at least one type selected from the group consisting of trifluoropropylene carbonate and tetrafluoropropylene carbonate.

Further, the non-aqueous electrode may include γ-butyrolactone. In this case also, the reversible reaction of the silicon in the negative electrode and the elemental sulfur in the positive electrode with lithium can be easily carried out at room temperature, so as to facilitate the charging/discharging reaction at room temperature.

The silicon may be an amorphous silicon thin film or a microcrystalline silicon thin film. In this case, further increased negative electrode capacity can be achieved.

The positive electrode may include an electrode impregnated with the non-aqueous electrolyte obtained by processing an electrode including elemental sulfur under reduced-pressure with the electrode immersed in the non-aqueous electrolyte.

In this case, because the electrode including elemental sulfur constituting the positive electrode is sufficiently impregnated with the non-aqueous electrolyte, charging/discharging can be performed at room temperature, and much increased energy density can be achieved.

A conductive agent may be added to the positive electrode. This enhances the conductivity of the positive electrode. As a result, the charge-discharge characteristics can be enhanced.

A non-aqueous electrolyte secondary battery according to another aspect of the present invention comprises a positive electrode, a negative electrode, and a non-aqueous electrolyte, the negative electrode including silicon that stores lithium, the non-aqueous electrolyte including a room temperature molten salt having a melting point of not higher than 60° C. and a reduction product of elemental sulfur.

In the non-aqueous electrolyte secondary battery according to the present invention, the inclusion of the room temperature molten salt having a melting point of not higher than 60° C. and the reduction product of elemental sulfur in the non-aqueous electrolyte enables the silicon in the negative electrode to easily react with lithium also at room temperature, so as to facilitate the charging/discharging at room temperature. Accordingly, increased capacity and energy density can be realized.

The positive electrode may include elemental sulfur. In this case, the combination of the positive electrode including elemental sulfur and the negative electrode including silicon that stores lithium enables the elemental sulfur in the positive electrode and the silicon in the negative electrode to reversibly react with lithium. In this case, the use of silicon that stores lithium for the negative electrode can increase the negative electrode capacity, and the use of elemental sulfur for the positive electrode can increase the positive electrode capacity. Accordingly, the negative electrode capacity and the positive electrode capacity can be easily balanced, so that further increased capacity and energy density can be realized.

The reduction product of elemental sulfur may be obtained by reducing elemental sulfur in a room temperature molten salt having a melting point of not higher than 60° C. and an organic electrolyte. In this case, the reversible reaction of the silicon in the negative electrode and the elemental sulfur in the positive electrode with lithium can be more easily carried out also at room temperature, so as to further facilitate the charging/discharging reaction at room temperature.

The silicon may be an amorphous silicon thin film or a microcrystalline silicon thin film. In this case, further increased negative electrode capacity can be achieved.

At least one type selected from the above-mentioned room temperature molten salts may be used. Preferably, the room temperature molten salt includes at least one type selected from the group consisting of trimethylpropylammonium bis(trifluoromethylsulfonyl)imide, trimethylhexylammonium bis(trifluoromethylsulfonyl)imide, and triethylmethylammonium 2,2,2-trifluoro-N-(trifluoromethylsulfonyl)acetamide.

A conductive agent may be added to the positive electrode. This enhances the conductivity of the positive electrode. As a result, the charge-discharge characteristics can be enhanced.

Further, the non-aqueous electrolyte may include γ-butyrolactone. In this case also, the reversible reaction of the silicon in the negative electrode and the elemental sulfur in the positive electrode can be easily carried out at room temperature, so as to facilitate the charging/discharging reaction at room temperature.

A method of manufacturing a positive electrode according to still another aspect of the present invention includes the step of processing an electrode including elemental sulfur under reduced-pressure with the electrode immersed in a non-aqueous electrolyte, thereby impregnating the electrode with the non-aqueous electrolyte.

In the method of manufacturing the positive electrode according to the present invention, the electrode including elemental sulfur can be sufficiently impregnated with the non-aqueous electrolyte. Accordingly, also in a non-aqueous electrolyte secondary battery using a positive electrode including elemental sulfur, the charging/discharging reaction can be carried out at room temperature, and much increased energy density can be achieved.

A pressure during the reduced-pressure process may be set to not higher than 28000 Pa (−55 cmHg with respect to atmospheric pressure). This allows the electrode including elemental sulfur to be more sufficiently impregnated with the non-aqueous electrolyte.

A positive electrode according to still another aspect of the present invention comprises an electrode impregnated with a non-aqueous electrolyte obtained by processing an electrode including elemental sulfur under reduced-pressure with the electrode immersed with a non-aqueous electrolyte.

In the positive electrode according to the present invention, because the electrode including elemental sulfur is sufficiently impregnated with the electrolyte, the charging/discharging reaction can be carried out at room temperature, and much increased energy can be achieved, when used in a non-aqueous electrolyte secondary battery.

A method of manufacturing a non-aqueous electrolyte secondary battery according to still another aspect of the present invention includes the step of preparing a positive electrode by processing an electrode including elemental sulfur under reduced-pressure with the electrode immersed in a non-aqueous electrolyte.

In the method of manufacturing the non-aqueous electrolyte secondary battery according to the present invention, a non-aqueous electrolyte secondary battery comprising a positive electrode including elemental sulfur sufficiently impregnated with a non-aqueous electrolyte can be manufactured. This enables the charging/discharging reaction to be carried out at room temperature, and much increased energy density can be achieved.

A non-aqueous electrolyte secondary battery according to still another aspect of the present invention comprises a positive electrode impregnated with a non-aqueous electrolyte obtained by processing an electrode including elemental sulfur with reduce-pressure with the electrode immersed in a non-aqueous electrolyte; a negative electrode; and a non-aqueous electrode including a room temperature molten salt having a melting point of not higher than 60° C.

In the non-aqueous electrolyte secondary battery according to the present invention, because the electrode including elemental sulfur constituting the positive electrode is sufficiently impregnated with the non-aqueous electrolyte, and the non-aqueous electrolyte includes the room temperature molten salt having a melting point of not higher than 60° C., the charging/discharging reaction can be carried out at room temperature, and much increased energy density can be achieved.

The room temperature molten salt may include a quaternary ammonium salt. At least one type selected from the above-mentioned quaternary ammonium salts may be used.

Preferably, the quaternary ammonium salt includes at least one type selected from the group consisting of trimethylpropylammonium bis(trifluoromethylsulfonyl)imide, trimethylhexylammonium bis(trifluoromethylsulfonyl)imide, and triethylmethylammonium 2,2,2-trifluoro-N-(trifluoromethylsulfonyl)acetamide.

The non-aqueous electrolyte may include at least one type of solvent selected from the group consisting of cyclic ethers, chain ethers, and fluorinated carbonates.

At least one type from the above-mentioned cyclic ethers may be used. At least one type from the above-mentioned chain ethers may be used. At least one type from the above-mentioned fluorinated carbonates may be used.

The cyclic ether may preferably include at least one type selected from the group consisting of 1,3-dioxolane and tetrahydrofuran; the chain ether may preferably include 1,2-dimethoxyethane; and the fluorinated carbonate may preferably include at least one type selected from the group consisting of trifluoropropylene carbonate and tetrafluoropropylene carbonate.

A conductive agent may be added to the positive electrode. This enhances the conductivity of the positive electrode. As a result, the charging-discharging characteristics can be enhanced.

The negative electrode may include a carbon material or a silicon material. In particular, in the case of the negative electrode including a silicon material, further increased energy density can be achieved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram for use in explaining a test cell prepared in each of Inventive Examples 1 to 23 and Comparative Examples 1 to 6 of this invention;

FIG. 2 is a diagram showing the cyclic voltammetry of a working electrode measured by scanning the potential of the working electrode in the test cell of Inventive Example 1;

FIG. 3 is a diagram showing the cyclic voltammetry of a working electrode measured by scanning the potential of the working electrode in the test cell of Comparative Example 1;

FIG. 4 is a diagram showing initial charge-discharge characteristics of the test cell of Inventive Example 1;

FIG. 5 is a diagram showing the discharge capacity and charge-discharge efficiency in each cycle obtained when the test cell of Inventive Example 1 was repeatedly charged/discharged;

FIG. 6 is a diagram showing initial charge-discharge characteristics of the test cell of Inventive Example 2;

FIG. 7 is a diagram showing the discharge capacity and charge-discharge efficiency in each cycle obtained when the test cell of Inventive Example 2 was repeatedly charged/discharged;

FIG. 8 is a diagram showing the cyclic voltammetry of a working electrode measured by scanning the potential of the working electrode in the test cell of Inventive Example 3;

FIG. 9 is a diagram showing the cyclic voltammetry of a working electrode measured by scanning the potential of the working electrode in the test cell of Comparative Example 2;

FIG. 10 is a diagram showing initial charge/discharge characteristics of the test cell of Inventive Example 4;

FIG. 11 is a diagram showing the discharge capacity and charge-discharge efficiency in each cycle obtained when the test cell of Inventive Example 5 was repeatedly charged/discharged;

FIG. 12 is a diagram showing the cyclic voltammetry of a working electrode measured by scanning the working electrode in the test cell of Inventive Example 5;

FIG. 13 is a diagram showing initial charge/discharge characteristics of the test cell of Inventive Example 5;

FIG. 14 is a diagram showing the cyclic voltammetry of a working electrode measured by scanning the working electrode in the test cell of Inventive Example 6;

FIG. 15 is a diagram showing the cyclic voltammetry of a working electrode measured by scanning the working electrode in the test cell of Inventive Example 7;

FIG. 16 is a diagram showing initial charge/discharge characteristics of the test cell of Inventive Example 7;

FIG. 17 is a diagram showing initial charge/discharge characteristics of the test cell of Inventive Example 8;

FIG. 18 is a diagram showing the discharge capacity and charge-discharge efficiency in each cycle obtained when the test cell of Inventive Example 8 was repeatedly charged/discharged;

FIG. 19 is a diagram showing the cyclic voltammetry of a working electrode measured by scanning the working electrode in the test cell of Inventive Example 9;

FIG. 20 is a diagram showing initial charge/discharge characteristics of the test cell of Inventive Example 9;

FIG. 21 is a diagram showing initial charge/discharge characteristics of the test cell of Inventive Example 10;

FIG. 22 is a diagram showing the discharge capacity and charge-discharge efficiency in each cycle obtained when the test cell of Inventive Example 10 was repeatedly charged/discharged;

FIG. 23 is a diagram showing the cyclic voltammetry of a working electrode measured by scanning the working electrode in the test cell of Inventive Example 11;

FIG. 24 is a diagram showing initial charge/discharge characteristics of the test cell of Inventive Example 11;

FIG. 25 is a diagram showing initial charge/discharge characteristics of the test cell of Inventive Example 12;

FIG. 26 is a diagram showing the discharge capacity and charge-discharge efficiency in each cycle obtained when the test cell of Inventive Example 12 was repeatedly charged/discharged;

FIG. 27 is a diagram showing the cyclic voltammetry of a working electrode measured by scanning the working electrode in the test cell of Comparative Example 3;

FIG. 28 is a diagram showing initial charge/discharge characteristics of the test cell of Comparative Example 3;

FIG. 29 is a diagram showing the cyclic voltammetry of a working electrode measured by scanning the working electrode in the test cell of Inventive Example 13;

FIG. 30 is a diagram showing initial charge/discharge characteristics of the test cell of Inventive Example 13;

FIG. 31 is a diagram showing initial charge/discharge characteristics of the test cell of Inventive Example 14;

FIG. 32 is a diagram showing the discharge capacity and charge-discharge efficiency in each cycle obtained when the test cell of Inventive Example 14 was repeatedly charged/discharged;

FIG. 33 is a diagram showing the cyclic voltammetry of a working electrode measured by scanning the working electrode in the test cell of Inventive Example 15;

FIG. 34 is a diagram showing initial charge/discharge characteristics of the test cell of Inventive Example 15;

FIG. 35 is a diagram showing initial charge/discharge characteristics of the test cell of Inventive Example 16;

FIG. 36 is a diagram showing the discharge capacity and charge-discharge efficiency in each cycle obtained when the test cell of Inventive Example 16 was repeatedly charged/discharged;

FIG. 37 is a diagram showing the cyclic voltammetry of a working electrode measured by scanning the working electrode in the test cell of Comparative Example 4;

FIG. 38 is a diagram showing initial charge/discharge characteristics of the test cell of Comparative Example 4;

FIG. 39 is a diagram showing the cyclic voltammetry of a working electrode measured by scanning the working electrode in the test cell of Inventive Example 17;

FIG. 40 is a diagram showing initial charge/discharge characteristics of the test cell of Inventive Example 17;

FIG. 41 is a diagram showing initial charge/discharge characteristics of the test cell of Inventive Example 18;

FIG. 42 is a diagram showing the discharge capacity and charge-discharge efficiency in each cycle obtained when the test cell of Inventive Example 18 was repeatedly charged/discharged;

FIG. 43 is a diagram showing the cyclic voltammetry of a working electrode measured by scanning the working electrode in the test cell of Inventive Example 19;

FIG. 44 is a diagram showing initial charge/discharge characteristics of the test cell of Inventive Example 19;

FIG. 45 is a diagram showing initial charge/discharge characteristics of the test cell of Inventive Example 20;

FIG. 46 is a diagram showing the discharge capacity and charge-discharge efficiency in each cycle obtained when the test cell of Inventive Example 20 was repeatedly charged/discharged;

FIG. 47 is a diagram showing the cyclic voltammetry of a working electrode measured by scanning the working electrode in the test cell of Comparative Example 5;

FIG. 48 is a diagram showing initial charge/discharge characteristics of the test cell of Comparative Example 5;

FIG. 49 is a diagram showing initial charge/discharge characteristics of the test cell of Inventive Example 21;

FIG. 50 is a diagram showing the discharge capacity and charge-discharge efficiency in each cycle per 1 g of the total weight of a mixture of the agents of positive and negative electrodes when the test cell of Inventive Example 21 was repeatedly charged/discharged;

FIG. 51 is a diagram showing initial charge/discharge characteristics of the test cell of Inventive Example 22;

FIG. 52 is a diagram showing the discharge capacity and charge-discharge efficiency in each cycle per 1 g of the total weight of a mixture of the agents of positive and negative electrodes when the test cell of Inventive Example 22 was repeatedly charged/discharged;

FIG. 53 is a diagram showing the measurement results of initial charge-discharge characteristics of the test cell of Comparative Example 6;

FIG. 54 is a diagram showing the measurement results of initial charge-discharge characteristics of the test cell of Inventive Example 23.

### DESCRIPTION OF THE PREFERRED EMBODIMENTS

### (1) First Embodiment

Description will, hereinafter, be made of a non-aqueous electrolyte secondary battery according to a first embodiment of the present invention.

The non-aqueous electrolyte secondary battery according to the present embodiment comprises a negative electrode, a positive electrode, and a non-aqueous electrolyte.

The positive electrode has a positive electrode active material made of a mixture of elemental sulfur, a conductive agent, and a binder. As the conductive agent, a conductive carbon material, for example, may be used. It is noted that addition of too small an amount of conductive carbon material cannot sufficiently enhance the conductivity in the positive electrode, whereas addition of an excessive amount of the material decreases the ratio of elemental sulfur in the positive electrode, and fails to achieve high capacity. Accordingly, the amount of carbon material may be set in the range of 5 to 84% by weight of the whole positive electrode active material, preferably, in the range of 5 to 54% by weight, more preferably, in the range of 5 to 20% by weight.

As the negative electrode, silicon that stores lithium is used. For example, an amorphous silicon thin film or a microcrystalline silicon film is formed on a current collector made of a copper foil having an electrolytically treated surface. A thin film made of a mixture of amorphous silicon and microcrystalline silicon may also be used. As a film formation method, sputtering, plasma CVD (chemical vapor deposition), or the like may be used. In particular, it is preferable to use silicon with large capacity, as proposed in JP-2001-266851-A and JP-2002-83594-A (or WO01/029912.) For example, it is preferable to use a negative electrode made of silicon including a current collector made of a foil having a rough surface; a negative electrode made of silicon having a columnar structure; a negative electrode made of silicon in which copper (Cu) is diffused; or a negative electrode made of silicon having at least one of these characteristics. This enables a non-aqueous electrolyte secondary battery having increased energy density. In place of the silicon thin film, silicon powder formed using a binder may also be used.

As the non-aqueous electrolyte, a non-aqueous electrolyte including a room temperature molten salt having a melting point of not higher than 60° C. and a lithium salt may be used. Room temperature molten salts are liquids containing only ions, having fire-resistance and no vapor pressure. Hence, they are not decomposed or burned even at the time of abnormal operations, such as overcharging, and can be safely used without the provision of a protection circuit or the like.

It is necessary for the room temperature molten salt to remain liquid in a broad room temperature range, in general, in the range of −20° C. to 60° C. It is desired that the room temperature molten salt have a conductivity of not less than 10⁻⁴S/cm.

By the addition of a lithium salt, a room temperature molten salt will probably have a lower melting point than the melting point of each of the two types of salts alone, and these are maintained in a liquid state.

As the non-aqueous electrolyte salt, a non-aqueous electrolyte salt including a quaternary ammonium salt and a lithium salt may also be used.

Further, as the non-aqueous electrolyte salt, a non-aqueous electrolyte salt including a room temperature molten salt having a melting point of not higher than 60° C. and a reduction product of elemental sulfur may be used. The reduction product of elemental sulfur may be obtained by reducing elemental sulfur in a room temperature molten salt having a melting point of not higher than 60° C. and an organic electrolyte.

As the non-aqueous electrolyte, γ-butyrolactone may also be used.

As the room temperature molten salt, a quaternary ammonium salt or an imidazolium salt may be used, for example. Specifically, as the room temperature molten salt, at least one type selected from trimethylpropylammonium bis(trifluoromethylsulfonyl)imide ((CH₃)₃N⁺(C₃H₇)N⁻(SO₂CF₃)₂), trimethyloctylammonium bis(trifluoromethylsulfonyl)imide ((CH₃)₃N⁺(C₈H₁₇)N⁻(SO₂CF₃)₂), trimethylallylammonium bis(trifluoromethylsulfonyl)imide ((CH₃)₃N⁺(Allyl)N⁻(SO₂CF₃)₂, trimethylhexylammonium bis(trifluoromethylsulfonyl)imide ((CH₃)₃N⁺(C₆H₁₃)N⁻(SO₂CF₃)₂), trimethylethylammonium 2,2,2-trifluoro-N-(trifluoromethylsulfonyl)acetamide ((CH₃)₃N⁺(C₂H₅)(CF₃CO)N⁻(SO₂CF₃)), trimethylallylammonium 2,2,2-trifluoro-N-(trifluoromethylsulfonyl)acetamide ((CH₃)₃N⁺(Allyl)(CF₃CO)N⁻(SO₂CF₃)), trimethylpropylammonium 2,2,2-trifluoro-N-(trifluoromethylsulfonyl)acetamide ((CH₃)₃N⁺(C₃H₇)(CF₃CO)N⁻(SO₂CF₃)), tetraethylammonium 2,2,2-trifluoro-N-(trifluoromethylsulfonyl)acetamide ((C₂H₅)₄N⁺(CF₃CO)N⁻(SO₂CF₃)), triethylmethylammonium 2,2,2-trifluoro-N-(trifluoromethylsulfonyl)acetamide ((C₂H₅)₃N⁺(CH₃)(CF₃CO)N⁻(SO₂CF₃)), 1-ethyl-3-methylimidazolium bis(pentafluoroethylsulfonyl)imide ((C₂H₅)(C₃H₃N₂)⁺(CH₃)N⁻(SO₂C₂F₅)₂) 1-ethyl-3-methylimidazolium bis(trifluoromethylsulfonyl)imide ((C₂H₅)(C₃H₃N₂)⁺(CH₃)N⁻(SO₂CF₃)₂), 1-ethyl-3-methylimidazolium tetrafluoroborate ((C₂H₅)(C₃H₃N₂)⁺(CH₃)BF₄⁻), 1-ethyl-3-methylimidazolium pentafluoroborate ((C₂H₅)(C₃H₃N₂)⁺(CH₃)PF₆⁻), and the like.

As the quaternary ammonium salt, instead of the above-mentioned quaternary ammonium salt for use as a room temperature molten salt, at least one type selected from tetramethylammonium tetrafluroborate ((CH₃)₄N⁺BF₄⁻), tetramethylammonium hexafluorophosphate ((CH₃)₄N⁺PF₆⁻), tetraethylammonium tetrafluroborate ((C₂H₅)₄N⁺BF₄⁻), tetraethylammonium hexafluorophosphate ((C₂H₅)₄N⁺PF₆⁻), and the like may be use.

It is noted that the above-mentioned non-aqueous electrolyte may include an organic solvent, such as ethylene carbonate, diethyl carbonate, dimethyl carbonate, propylene carbonate, cyclic ether, chain ether, fluorinated carbonate, in addition to the room temperature molten salt or quaternary ammonium salt.

As the cyclic ether, at least one type selected from 1,3-dioxolane, 2-methyl-1,3-dioxolane, 4-methyl-1,3-dioxolane, tetrahydrofuran, 2-methyl tetrahydrofuran, propylene oxide, 1,2-butylene oxide, 1,4-dioxiane, 1,3,5-trioxane, furan, 2-methy furan, 1,8-cineole, crown ether, and the like may be used.

As the chain ether, at least one type selected from 1,2-dimethoxyethane, diethyl ether, dipropyl ether, diiusopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1, 1-dimethoxymethane, 1,1-diethoxyethane, triethylene glycol dimethyl ether, tetraethylene glycol dimethyl ether, and the like may be used. As the fluorinated carbonate, at least one type selected from trifluoropropylene carbonate, tetrafluoropropylene carbonate, fluoroethyl carbonate, and the like may be used.

As the lithium salt to be added to the non-aqueous electrolyte, a lithium salt used as an electrolyte in general non-aqueous electrolyte secondary battery may be used. For example, at least one type selected from LiBF₄, LiPF₆, LiCF₃SO₃, LiC₄F₉SO₃, LiN(CF₃SO₂)₂, LiN(C₂F₅S₂)₂, LiN(CF₃SO₂)(COCF₃), and LiAsF₆ may be used.

Another possibility is the gelation of the non-aqueous electrolyte using polyethylene oxide (PEO), for example, for preventing the elution of elemental sulfur to allow the reversible reaction of the elemental sulfur. As the non-aqueous electrolyte, a gelled polymer electrolyte in which a polymer electrolyte such as polyethylene oxide, polyacrylonitrile, or the like is impregnated with an electrolyte salt, or an inorganic solid electrolyte such as LiI or Li₃N may also be used.

In the non-aqueous electrolyte secondary battery according to the present embodiment, the combination of the positive electrode including elemental sulfur and the negative electrode including silicon that stores lithium allows the elemental sulfur in the positive electrode and the silicon in the negative electrode to react reversibly with the lithium at relatively low temperatures. In this case, high negative electrode capacity can be obtained using silicon that stores lithium. Moreover, the use of elemental sulfur in the positive electrode allows increased capacity per unit weight compared with that obtained using an organic disulfide compound. Consequently, the negative and positive electrode capacities can be easily balanced, and increased capacity and energy density can be realized.

In the case of the non-aqueous electrolyte including a room temperature molten salt having a melting point of not higher than 60° C., a quaternary ammonium salt, a reduction product of elemental sulfur, or y-butyrolactone, the silicon in the negative electrode and elemental sulfur in the positive electrode easily react reversibly with lithium also at room temperature, and hence the charge-discharge reaction at room temperature can be facilitated.

### (2) Second Embodiment

Description will then be made of a non-aqueous electrolyte secondary battery according to a second embodiment and method of manufacturing the same.

The non-aqueous electrolyte secondary battery according to the present embodiment comprises a negative electrode, a positive electrode, and a non-aqueous electrolyte.

The positive electrode has a positive electrode active material made of a mixture of elemental sulfur, a conductive agent, and a binder. The electrode having the positive electrode active material is subjected to reduced-pressure process while immersed in the non-aqueous electrolyte. A pressure during the reduced-pressure process is preferably not higher than 28000 Pa (−55 cmHg with respect to atmospheric pressure.) This allows the electrode including elemental sulfur to be sufficiently impregnated with the non-aqueous electrolyte.

As the conductive agent, a conductive carbon material, for example, may be used. It is noted that addition of too small an amount of conductive carbon material cannot sufficiently enhance the conductivity in the positive electrode, whereas addition of an excessive amount of the material decreases the ratio of elemental sulfur in the positive electrode, and fails to achieve high capacity. Accordingly, the amount of carbon material may be set in the range of 5 to 84% by weight of the whole positive electrode active material, preferably, in the range of 5 to 54% by weight, more preferably, in the range of 5 to 20% by weight.

As the negative electrode, a carbon material, such as graphite, capable of storage and release of Li (lithium), Li metal, Li alloy, or the like is used.

Silicon that stores lithium may also be used as the negative electrode. For example, an amorphous silicon thin film or a microcrystalline silicon film may be formed on a current collector made of a copper foil or the like having an electrolytically treated surface. A thin film made of a mixture of amorphous silicon and microcrystalline silicon may also be used. As a film formation method, sputtering, plasma CVD (chemical vapor deposition), or the like may be used. In particular, it is preferable to use silicon with large capacity, as proposed in JP-2001-266851-A and JP-2002-83594-A (or WO01/029912.) This enables a non-aqueous electrolyte secondary battery having increased energy density.

In the non-aqueous electrolyte secondary battery according to the present embodiment, lithium involving the charge-discharge reaction is held either in the above-mentioned positive electrode or negative electrode.

As the non-aqueous electrolyte, a non-aqueous electrolyte including a room temperature molten salt having a melting point of not higher than 60° C. and a lithium salt may be used, as in the first embodiment.

The non-aqueous electrolyte may further include an organic solvent in addition to the room temperature molten salt having a melting point of not higher than 60° C. and the lithium salt.

The room temperature molten salt and quaternary ammonium salt used as the non-aqueous electrolyte are the same as those in the first embodiment. The organic solvent to be added to the non-aqueous electrolyte is also the same as that in the first embodiment. Further, the lithium salt to be added to the non-aqueous electrolyte is the same as that in the first embodiment.

In the non-aqueous electrolyte secondary battery according to the present embodiment, the above-mentioned use of intact elemental sulfur in the positive electrode allows further increased capacity per unit weight than that obtained using an organic disulfide compound. Moreover, the electrode having elemental sulfur can be sufficiently impregnated with the non-aqueous electrolyte because the electrode having the positive electrode active material is subjected to the reduced-pressure process while immersed in the non-aqueous electrolyte. Consequently, also in a non-aqueous electrolyte secondary battery using a positive electrode including elemental sulfur, the charge-discharge reaction can be carried out at room temperature, and the energy density can be much increased.

### Example (1)

It will now be apparent from the citation of Examples that the non-aqueous electrolyte secondary battery according to the present invention in which elemental sulfur is used for the positive electrode and a silicon material is used for the negative electrode can be appropriately charged/discharged at room temperature, and has much increased energy density. It will be recognized that the following examples merely illustrate the practice of the non-aqueous electrolyte secondary battery in the present invention but are not intended to be limiting thereof. Suitable changes and modifications can be effected without departing the scope of the present invention.

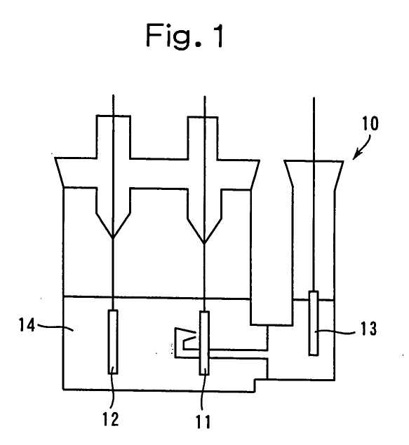

In Inventive Examples 1 to 20 and Comparative Examples 1 to 5 described below, the test cell shown in FIG. 1 was prepared to evaluate a positive electrode including sulfur and a negative electrode including a silicon material.

As shown in FIG. 1, a non-aqueous electrolyte 14 was poured into a test cell vessel 10, and a working electrode 11 and a reference electrode 13 were immersed in the non-aqueous electrolyte 14.

In Inventive Examples 1, 3, 5, 7, 9, 11, 13, 15, 17, 19, and Inventive Examples 1 to 5, positive electrodes including elemental sulfur as active materials were evaluated, whereas in Inventive Examples 2, 4, 6, 8, 10, 12, 14, 16, 18, and 20, negative electrodes made of silicon materials were evaluated.

Tables 1 and 2 summarize the compositions of test cells in Inventive Examples 1 to 20 and Comparative Examples 1 to 5.

TABLE 1

| | working | | | |
|---|---|---|---|---|
| | electrode | counter electrode | solute | non-aqueous electrolyte |
| Inventive | sulfur | Li metal | LiN(CF₃SO₂)₂ | room temperature |
| example 1 | | | | molten salt 1(quaternary |
| | | | | ammonium salt) |
| Comparative | sulfur | Li metal | LiPF₆ | EC/DEC |
| example 1 | | | | |
| Inventive | amorphous | Li metal | LiN(CF₃SO₂)₂ | room temperature |
| example 2 | silicon thin | | | molten salt 1(quaternary |
| | film | | | ammonium salt) |
| Inventive | sulfur | Li metal | LiPF₆ | fluorinated carbonate 1: |
| example 3 | | | | room temperature |
| | | | | molten salt 1(quaternary |
| | | | | ammonium salt) |
| Comparative | sulfur | Li metal | LiPF₆ | fluorinated carbonate 1 |
| example 2 | | | | |
| Inventive | amorphous | Li metal | LiPF₆ | fluorinated carbonate 1: |
| example 4 | silicon thin | | | room temperature |
| | film | | | molten salt 1(quaternary |
| | | | | ammonium salt) |
| Inventive | sulfur | Li metal | LiN(CF₃SO₂)₂ | room temperature |
| example 5 | | | | molten salt 2(quaternary |
| | | | | ammonium salt) |
| Inventive | amorphous | Li metal | LiN(CF₃SO₂)₂ | room temperature |
| example 6 | silicon thin | | | molten salt 2(quaternary |
| | film | | | ammonium salt) |
| Inventive | sulfur | Li metal | LiN(CF₃SO₂)₂ | room temperature |
| example 7 | | | | molten salt 3(quaternary |
| | | | | ammonium salt) |
| Inventive | amorphous | Li metal | LiN(CF₃SO₂)₂ | room temperature |
| example 8 | silicon thin | | | molten salt 3(quaternary |
| | film | | | ammonium salt) |
| Inventive | sulfur | Li metal | LiN(CF₃SO₂)₂ | cyclic ether 1: |
| example 9 | | | | room temperature |
| | | | | molten salt 1(quaternary |
| | | | | ammonium salt) = 50:50 |
| Inventive | amorphous | Li metal | LiN(CF₃SO₂)₂ | cyclic ether 1: |
| example 10 | silicon thin | | | room temperature |
| | film | | | molten salt 1(quaternary |
| | | | | ammonium salt) = 50:50 |

TABLE 2

| | working | | | |
|---|---|---|---|---|
| | electrode | counter electrode | solute | non-aqueous electrolyte |
| Inventive | sulfur | Li metal | LiN(CF₃SO₂)₂ | cyclic ether 1: |
| example 11 | | | | room temperature |
| | | | | molten salt 1(quaternary |
| | | | | ammonium salt) = 25:75 |
| Inventive | amorphous | Li metal | LiN(CF₃SO₂)₂ | cyclic ether 1: |
| example 12 | silicon thin | | | room temperature |
| | film | | | molten salt 1(quaternary |
| | | | | ammonium salt) = 25:75 |
| Comparative | sulfur | Li metal | LiN(CF₃SO₂)₂ | cyclic ether 1 |
| example 3 | | | | |
| Inventive | sulfur | Li metal | LiN(CF₃SO₂)₂ | cyclic ether 2: |
| example 13 | | | | room temperature |
| | | | | molten salt 1(quaternary |
| | | | | ammonium salt) = 50:50 |
| Inventive | amorphous | Li metal | LiN(CF₃SO₂)₂ | cyclic ether 2: |
| example 14 | silicon thin | | | room temperature |
| | film | | | molten salt 1(quaternary |
| | | | | ammonium salt) = 50:50 |
| Inventive | sulfur | Li metal | LiN(CF₃SO₂)₂ | cyclic ether 2: |
| example 15 | | | | room temperature |
| | | | | molten salt 1(quaternary |
| | | | | ammonium salt) = 25:75 |
| Inventive | amorphous | Li metal | LiN(CF₃SO₂)₂ | cyclic ether 2: |
| example 16 | silicon thin | | | room temperature |
| | film | | | molten salt 1(quaternary |
| | | | | ammonium salt) = 25:75 |
| Comparative | sulfur | Li metal | LiN(CF₃SO₂)₂ | cyclic ether 2 |
| example 4 | | | | |
| Inventive | sulfur | Li metal | LiN(CF₃SO₂)₂ | chain ether 1: |
| example 17 | | | | room temperature |
| | | | | molten salt 1(quaternary |
| | | | | ammonium salt) = 50:50 |
| Inventive | amorphous | Li metal | LiN(CF₃SO₂)₂ | chain ether 1: |
| example 18 | silicon thin | | | room temperature |
| | film | | | molten salt 1(quaternary |
| | | | | ammonium salt) = 50:50 |
| Inventive | sulfur | Li metal | LiN(CF₃SO₂)₂ | chain ether 1: |
| example 19 | | | | room temperature |
| | | | | molten salt 1(quaternary |
| | | | | ammonium salt) = 25:75 |
| Inventive | amorphous | Li metal | LiN(CF₃SO₂)₂ | chain ether 1: |
| example 20 | silicon thin | | | room temperature |
| | film | | | molten salt 1(quaternary |
| | | | | ammonium salt) = 25:75 |
| Comparative | sulfur | Li metal | LiN(CF₃SO₂)₂ | chain ether 1 |
| example 5 | | | | |

### Inventive Example 1

In Inventive Example 1, a non-aqueous electrolyte including a lithium salt, LiN(CF₃SO₂)₂, dissolved at a concentration of 0.3 mol/l in a room temperature molten salt, trimethylpropylammonium bis(trifluoromethylsulfonyl)imide ((CH₃)₃N⁺(C₃H₇)N⁻(SO₂CF₃)₂) was used.

For a positive electrode, 20% by weight of elemental sulfur, 70% by weight of acetylene black as conductive agent, and 10% by weight of polytetrafluoroethylene as binder were mixed, and the resultant mixture was ground in a mortar for 30 minutes, then pressed in a mold for five seconds under a pressure of 150 kg/cm² to give a disk-shaped material having a diameter of 10.3 mm. This material was wrapped in a net made of aluminum to be used as a positive electrode.

As shown in FIG. 1, the above-mentioned non-aqueous electrolyte 14 was poured into the test cell vessel 10, while the above-mentioned positive electrode was used for a working electrode 11, and lithium metal was used for each of a negative electrode as a counter electrode 12 and a reference electrode 13, to prepare a test cell of Inventive Example 1.

### Comparative Example 1

In Comparative Example 1, a non-aqueous electrolyte including a lithium salt, LiPF₆ dissolved at a concentration of 1 mol/l in a mixed solvent of ethylene carbonate (EC) and diethyl carbonate (DEC) at a volume ratio of 1:1 was used. Otherwise, the test cell of Comparative Example 1 was prepared as in the case of the above-mentioned Inventive Example 1.

### Evaluation 1

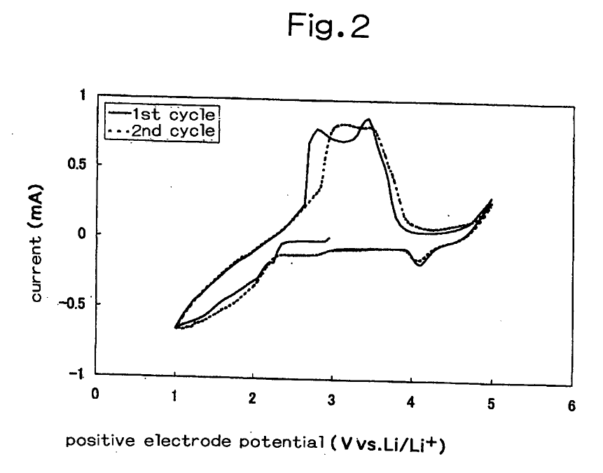

Using the test cell of Inventive Example 1 prepared as shown above, the potential of the active electrode 11 (positive electrode) relative to the reference electrode 13 was scanned starting at an initial potential of 2.9 V (vs. Li/Li⁺) in a reduction direction, and then in an oxidation direction for two cycles, at a scan rate of 0.5 mV/s in a scan range of 1.0 to 5.0 V (vs. Li/Li⁺), to measure the cyclic voltammetry in each cycle. The results are given in FIG. 2.

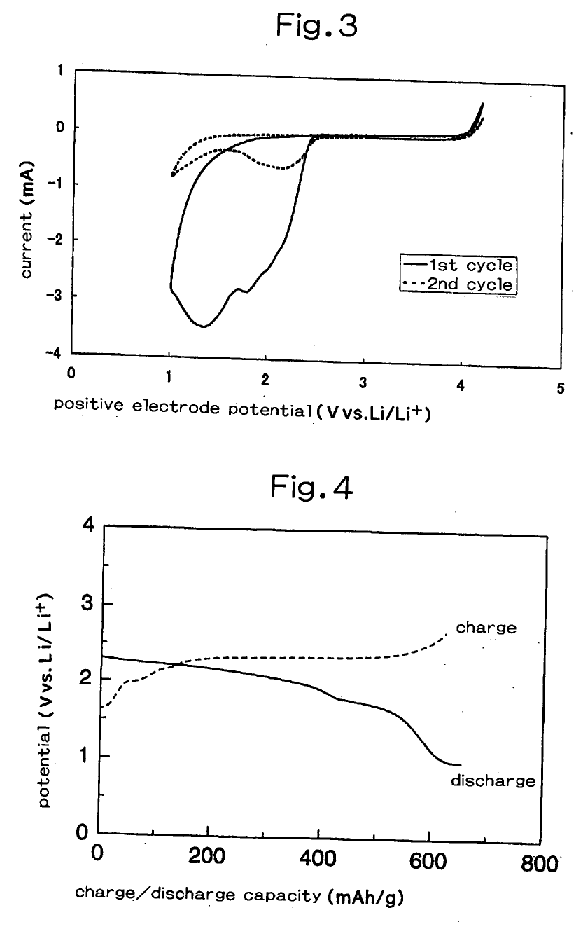

Using the test cell of Comparative Example 1 prepared as shown above, the potential of the active electrode 11 (positive electrode) relative to the reference electrode 13 was scanned starting at an initial potential of 3.0 V (vs. Li/Li⁺) in a reduction direction, and then in an oxidation direction for two cycles, at a scan rate of 0.5 mV/s in a scan range of 1.0 to 4.2 V (vs. Li/Li⁺), to measure the cyclic voltammetry in each cycle. The results are given in FIG. 3.

As a result, in the case of the test cell of Inventive Example 1, an abrupt reduction current began to flow at around 2.3 V or lower (vs. Li/Li⁺) during scanning in the reduction direction, and so it is presumed that the elemental sulfur was reduced. In addition, there were oxidation peaks between around 2.6 and 3.9 V (vs. Li/Li⁺) during scanning in the oxidation direction, and so it is presumed that the above-mentioned reduced elemental sulfur was oxidized in this potential range. The same result was obtained also in the second cycle. It is therefore presumed that the reversible reaction of elemental sulfur was carried out.

In the case of the test cell of Comparative Example 1, a reduction current began to flow at around 2.4 V or lower (vs. Li/Li⁺) during scanning in the reduction direction, and so it is presumed that the elemental sulfur was reduced. However, there were no oxidation peaks during scanning in the oxidation direction, and so it is presumed that the above-mentioned reduced elemental sulfur was not oxidized. In addition, a small amount of reduction current flowed at around 2.4 V or lower (vs. Li/Li⁺) during scanning in the oxidation direction. This is probably due to the reduction of the residual elemental sulfur that was not reduced in the earlier reaction.

The test cell of Inventive Example 1 was discharged to adischarge cutoff potential of 1.0 V (vs. Li/Li⁺) at adischarge current of 0.13 mA/cm², and then charged to a charge cutoff potential of 2.7 V (vs. Li/Li⁺) at a charge current of 0.13 mA/cm², to examine the initial charge-discharge characteristics. The results are given in FIG. 4. Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in the test cell of Inventive Example 1, the initial specific discharge capacity was approximately 654 mAh/g per 1 g of elemental sulfur, which was lower than the theoretical capacity of 1675 mAh/g, but the specific discharge capacity was markedly increased, compared with that of LiCoO₂ used as a general positive electrode. Moreover, the initial specific discharge capacity per 1 g of elemental sulfur exhibited a value as large as approximately 623 mAh/g, and the reversible reaction of elemental sulfur was also proved.

Further, with this test cell of Inventive Example 1, the operation of discharging the cell to a discharge cutoff potential of 1.0 V (vs. Li/Li⁺) at a discharge current of 0.13 mA/cm², and then charging the cell to a charge cutoff potential of 2.7 V (vs. Li/Li⁺) at a charge current of 0.13 mA/cm² was repeated, to measure the charge capacity Qₐ (mAh/g) and discharge capacity Q_{b} (mAh/g) in each cycle, and also find out the charge-discharge efficiency (%) in each cycle in accordance with the following equation. In FIG. 5, the white circle and solid line represent the discharge capacity (mAh/g) in each cycle, and the triangle and broken line represent the charge-discharge efficiency (%) in each cycle.

Charge-discharge efficiency=(Q_{b}/Qₐ)×100

As a result, in this test cell of Inventive Example 1, the specific discharge capacities in the third cycle and thereafter were kept constant at approximately 490 mAh/g, and the charge-discharge efficiencies were also kept constant at approximately 100%.

It is noted that in the test cell of Inventive Example 1, the average discharge voltage was approximately 2 V and the energy density per 1 g of elemental sulfur was approximately 980mWh/g. Theenergy densitywasmarkedlyincreased, compared with the energy density per lg of LiCoO₂ (approximately 540 mWh/g) used as a general positive electrode.

### Inventive Example 2

In Inventive Example 2, the same non-aqueous electrolyte as that in the above-mentioned Inventive Example 1 was used. As a working electrode 11, an amorphous silicon thin film formed by sputtering on a copper foil having an electrolytically treated surface and formed into a 2 cm×2 cm size was used.

A DC pulse sputtering apparatus was used. An argon (Ar) gas was used for atmospheric gas, and a 99.999% single silicon crystal for a target. The flow rate of the argon gas was set to 60 sccm, and the pressure of the sputtering atmosphere was set to 2×10⁻¹ Pa. The electric power of sputtering was set to 2000 W (6.7 W/cm².)

The initial substrate temperature was set to 25° C. The maximum temperature was approximately 100° C. metal was used for each of a counter electrode 12 and a reference electrode 13, to prepare a test cell of Inventive Example 2.

### Evaluation 2

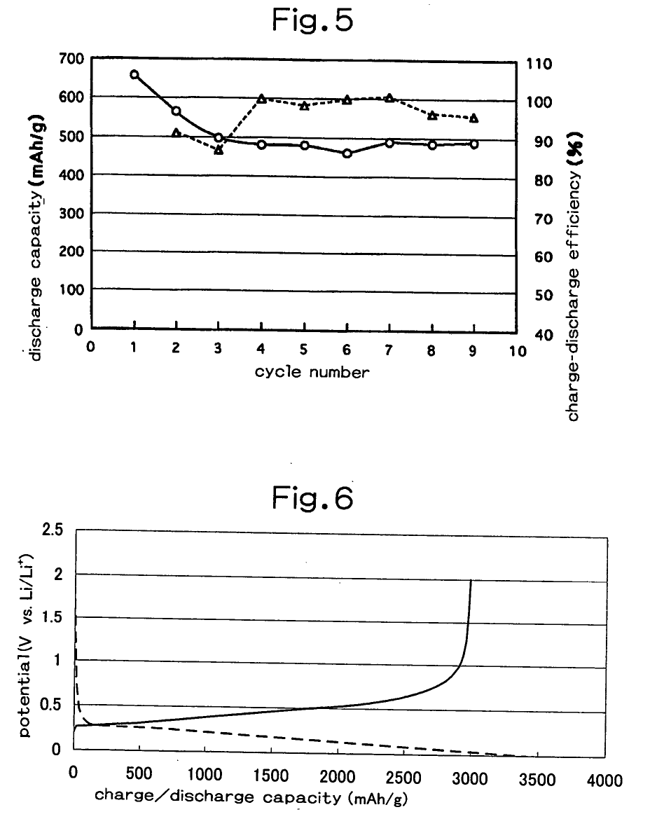

The test cell of Inventive Example 2 was discharged to a discharge cutoff potential of 0.0 V (vs. Li/Li⁺) at a discharge current of 0.05 mA/cm2 , and then charged to a charge cutoff potential of 2.0 V (vs. Li/Li⁺) at a charge current of 0.05 mA/cm², to examine the initial charge-discharge characteristics. The results are given in FIG. 6. Note that the solid line represents a discharge curve showing the relationship between the potential and the active material per 1 g of elemental sulfur during charging, and the broken line represents a charge curve showing the relationship between the potential and the active material per 1 g of elemental sulfur during discharging.

As a result, in the test cell of Inventive Example 2, the initial specific charge and discharge capacities per 1 g of the active material were approximately 3417 mAh/g and 2989 mAh/g, respectively. The specific charge/discharge capacity was markedly increased, compared with that of a carbon material used as a general negative electrode. Moreover, the reversible reaction of elemental sulfur was also proved.

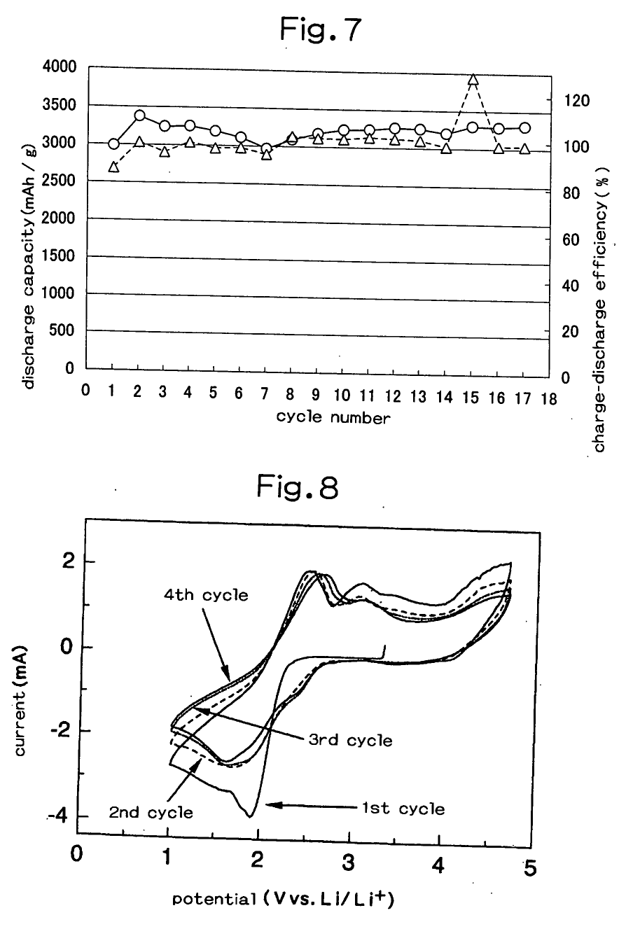

Further, with this test cell of Inventive Example 2, the operation of charging the cell to a charge cutoff potential of 0.0 V (vs. Li/Li⁺) at a charge current of 0.05 mA/cm², and then discharging the cell to a discharge cutoff potential of operation of charging the cell to a charge cutoff potential of 0.0 V (vs. Li/Li⁺) at a charge current of 0.05 mA/cm², and then discharging the cell to a discharge cutoff potential of 2.0 V (vs. Li/Li⁺) at a discharge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the above-mentioned equation. In FIG. 7, the white circle and solid line represent the discharge capacity (mAh/g) in each cycle, and the triangle and broken line represent the charge-discharge efficiency (%) in each cycle.

As a result, in this test cell of Inventive Example 2, the discharge capacities in the third cycle and thereafter were kept constant at approximately 3243 mAh/g, and the charge-discharge efficiencies were also kept constant at approximately 94%.

### Inventive Example 3

In Inventive Example 3, a non-aqueous electrolyte including a lithium salt, LiPF₆ dissolved at a concentration of 1 mol/l in a mixed solvent of tetrafluoropropylene carbonate and a quaternary ammonium salt, trimethylpropylammonium bis(trifluoromethylsulfonyl)imide ((CH₃)₃N⁺(C₃H₇)N⁻(SO₂CF₃)₂) at a volume ratio of 1:1 was used. Otherwise, test cell of Inventive Example 3 was prepared as in the case of the above-mentioned Inventive Example 1.

### Comparative Example 2

In Comparative Example 2, a non-aqueous electrolyte including a lithium salt, LiPF₆ dissolved at a concentration of 1 mol/l in tetrafluoropropylene carbonate was used. Otherwise, the test cell of Comparative Example 2 was prepared as in the case of the above-mentioned Inventive Example 1.

### Evaluation 3

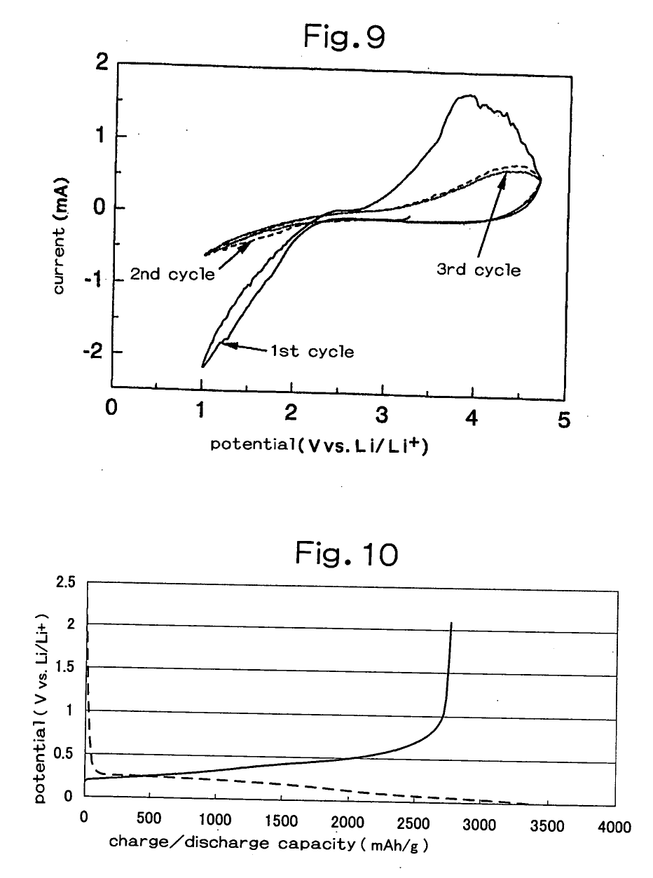

Using each of the test cells of Inventive Example 3 and Comparative Example 2 thus prepared, the electrode 11 relative to the reference electrode 13 was scanned starting at an initial potential of 3.34 V (vs. Li/Li⁺) in a reduction direction, and then in an oxidation direction, at a scan rate of 1.0 mV/s in a scan range of 1.0 to 4.7 V (vs. Li/Li⁺), to measure the cyclic voltammetry in each cycle. The scanning operations were performed for four cycles in the test cell of Inventive Example 3, and for three cycles in the test cell of Comparative Example 2. The results of the test cell of Inventive Example 3 are given in FIG. 8, and the results of the test cell of Comparative Example 2 are given in FIG. 9.

As a result, in the case of the test cell of Inventive Example 3, a reduction current began to flow at around 2.3 V or lower (vs. Li/Li⁺) during scanning in the reduction direction, and so it is presumed that elemental sulfur was reduced. In addition, there were oxidation peaks between 2.0 and 3.0 V (vs. Li/Li⁺) during scanning in the oxidation direction, and so it is presumed that the above-mentioned reduced elemental sulfur was oxidized in this potential range. The same result was obtained also in the second cycle. It is therefore presumed that the reversible reaction of elemental sulfur was carried out.

In the case of the test cell of Comparative Example 2, a reduction current began to flow at around 2.2 V or lower (vs. Li/Li⁺) during scanning in the reduction direction, and so it is presumed that the elemental sulfur was reduced. However, there was an oxidation peak around 4.0 V (vs. Li/Li⁺) during scanning in the oxidation direction, and the energy efficiency was very poor. In the second cycle and thereafter, the oxidation peaks and the reduction currents abruptly decreased in size, and the resultant reversibility was poor.

The discharge potential of elemental sulfur given by the results of the above-mentioned test cell of Inventive Example 3 was approximately 2.0 V (vs. Li/Li⁺), and the energy density of elemental sulfur converted from the theoretical specific capacity of 1675 mAh/g was 3350 Wh/g. The energy density was markedly increased, compared with that of LiCoO₂ (approximately 540 mWh/g) used in a general positive electrode.

### Inventive Example 4

In Inventive Example 4, the same non-aqueous electrolyte as that in the above-mentioned Inventive Example 3 was used. Otherwise, the test cell of Example 3 was prepared as in the case of the above-mentioned Inventive Example 2.

### Evaluation 4

The test cell of Inventive Example 4 was charged to a charge cutoff potential of 0.0 V (vs. Li/Li⁺) at a charge current of 0.05 mA/cm², and then discharged to a discharge cutoff potential of 2.0 V (vs. Li/Li⁺) at a discharge current of 0.05 mA/cm², to examine the initial charge-discharge characteristics. The results are given in FIG. 10. Note that the solid line represents a discharge curve showing the relationship between the potential and the capacity per 1 g of active material during charging, and the broken line represents a charge curve showing the relationship between the potential and capacity per 1 g of active material during discharging.

As a result, in the test cell of Inventive Example 4, the initial specific charge and discharge capacities per 1 g of the active material were approximately 3380 mAh/g and 3695 mAh/g, respectively. The specific charge/discharge capacity was markedly increased, compared with that of a carbon material used in a general negative electrode. Moreover, the reversible reaction of the silicon thin film was also proved.

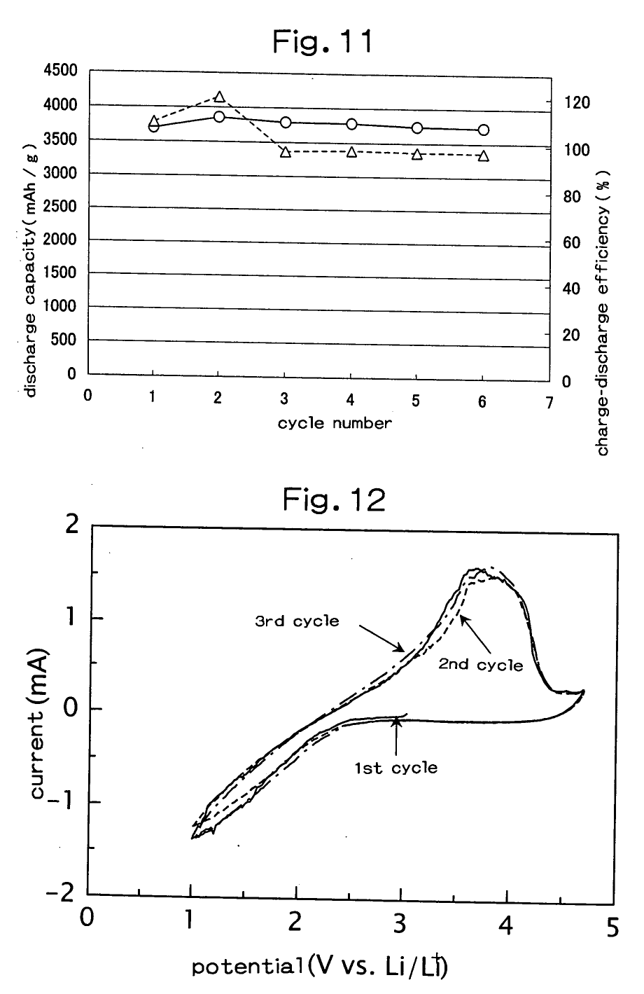

Further, with this test cell of Inventive Example 4, the operation of charging the cell to a charge cutoff potential of 0.0 V (vs. Li/Li⁺) at a charge current of 0.05 mA/cm², and then discharging the cell to a discharge cutoff potential of 2.0 V (vs. Li/Li⁺) at a discharge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the above-mentioned equation. In FIG. 11, the white circle and solid line represent the specific discharge capacity (mAh/g) in each cycle, and the triangle and broken line represent the charge-discharge efficiency (%) in each cycle.

As a result, in the test cell of Inventive Example 4, the specific discharge capacities in the third cycle and thereafter were kept constant at approximately 3897 mAh/g, and the charge-discharge efficiencies were also kept constant at approximately 97%.

### Inventive Example 5

In Inventive Example 5, a non-aqueous electrolyte including a lithium salt, LiN(CF₃SO₂)₂ dissolved at a concentration of 0.5 mol/l in a room temperature molten salt, triethylmethylammonium 2,2,2-trifluoro-N-(trifluoromethylsulfonyl)acetamide ((C₂H₅)₃N⁺(CH₃) (CF₃CO)N⁻(SO₂CF₃)) was used. Otherwise, the test cell of Example 5 was prepared as in the case of the above-mentioned Inventive Example 1.

### Evaluation 5

Using the test cell of Inventive Example 5 thus prepared, the potential of the active electrode 11 relative to the reference electrode 13 was scanned starting at an initial potential of 3.0 V (vs. Li/Li⁺) in a reduction direction, and then in an oxidation direction for three cycles, at a scan rate of 1.0 mV/s in a scan range of 1.0 to 4.7 V (vs. Li/Li⁺), to measure the cyclic voltammetry in each cycle. The results are given in FIG. 12.

As a result, in the case of the test cell of Inventive Example 5, a reduction current began to flow at around 2.3 V or lower (vs. Li/Li⁺) during scanning in the reduction direction, and so it is presumed that elemental sulfur was reduced. In addition, there was an oxidation peak around 3.8 V (vs. Li/Li⁺) during scanning in the oxidation direction, and so it is presumed that the above-mentioned reduced elemental sulfur was oxidized at around this potential. The same results were obtained also in the second cycle and thereafter. It is therefore presumed that the reversible reaction of elemental sulfur was carried out.

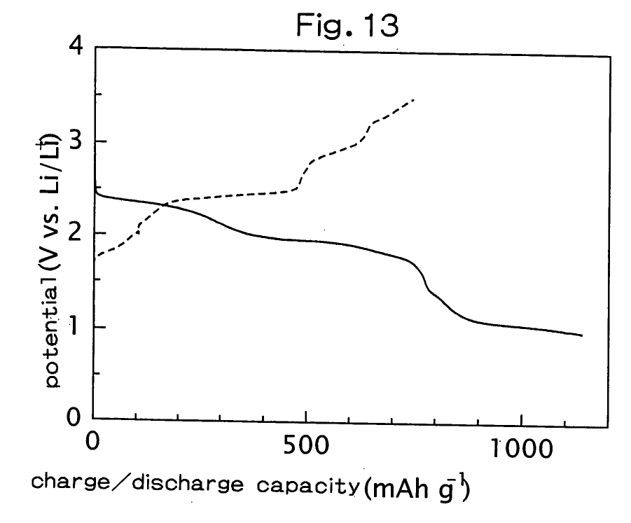

The test cell of Inventive Example 5 was discharged to a discharge cutoff potential of 1.0 V (vs. Li/Li⁺) at a discharge current of 0.13 mA/ cm², and then charged to a charge cutoff potential of 3.5V (vs. Li/Li⁺) at acharge current of 0. 13mA/cm², to examine the initial charge-discharge characteristics. The results are given in FIG. 13. Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in the test cell of Inventive Example 5, the initial specific discharge capacity per 1 g of elemental sulfur was approximately 1138 mAh/g. The specific discharge capacity was markedly increased, compared with that of LiCoO₂ used in a general positive electrode.

### Inventive Example 6)

In Inventive Example 6, the same non-aqueous electrolyte as that in the above-mentioned Inventive Example 5 was used. Otherwise, the test cell of Example 6 was prepared as in the case of the above-mentioned Inventive Example 2.

### Evaluation 6

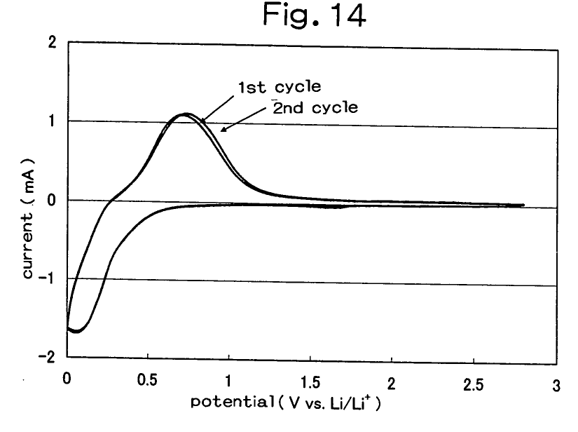

Using the test cell of Inventive Example 6 thus prepared, the potential of the active electrode 11 relative to the reference electrode 13 was scanned starting at an initial potential of 2.6 V (vs. Li/Li⁺) in a reduction direction, and then in an oxidation direction for three cycles, at a scan rate of 1.0 mV/s in a scan range of 0.0 to 2.75 V (vs. Li/Li⁺), to measure the cyclic voltammetry in each cycle. The results are given in FIG. 14.

As a result, in the case of the test cell of Example 6, there was a reduction peak around 0.03 V (vs. Li/Li⁺) during scanning in the reduction direction, and there was an oxidation peak around 0.7 V (vs. Li/Li⁺) during scanning in the oxidation direction. It is presumed that insertion/release of lithium into/from silicon occurred at around this potential. The same results were obtained in the second cycle and thereafter, and so it is presumed that the reversible reaction of silicon with lithium was carried out.

### Inventive Example 7

In Inventive Example 7, a non-aqueous electrolyte including a lithium salt, LiN(CF₃SO₂)₂ dissolved at a concentration of 0.5 mol/l in a room temperature molten salt, trimethylhexylammonium bis(trifluoromethylsulfonyl)imide ((CH₃)₃N⁺(C₆H₁₃)N⁻(SO₂CF₃)₂) was used. Otherwise, the test cell of Inventive Example 7 was prepared as in the case of the above-mentioned test cell of Inventive Example 1.

### Evaluation 7

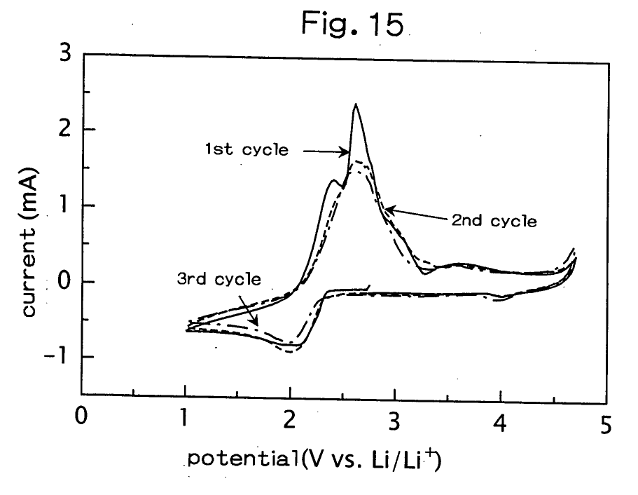

Using the test cell of Inventive Example 7 thus prepared, the potential of the active electrode 11 relative to the reference electrode 13 was scanned starting at an initial potential of 2.8 V (vs. Li/Li⁺) in a reduction direction, and then in an oxidation direction for three cycles, at a scan rate of 1.0 mV/s in a scan range of 1.0 to 4.7 V (vs. Li/Li⁺), to measure the cyclic voltammetry in each cycle. The results are given in FIG. 15.

As a result, in the case of the test cell of Inventive Example 7, a reduction current began to flow at around 2.3 V or lower (vs. Li/Li⁺) during scanning in the reduction direction, and so it is presumed that the elemental sulfur was reduced. In addition, there was an oxidation peak around 2.6 V (vs. Li/Li⁺) during scanning in the oxidation direction, and so it is presumed that the above-mentioned reduced elemental sulfur was oxidized at around this potential. The same results were obtained also in the second cycle and thereafter. It is therefore presumed that the reversible reaction of elemental sulfur was carried out.

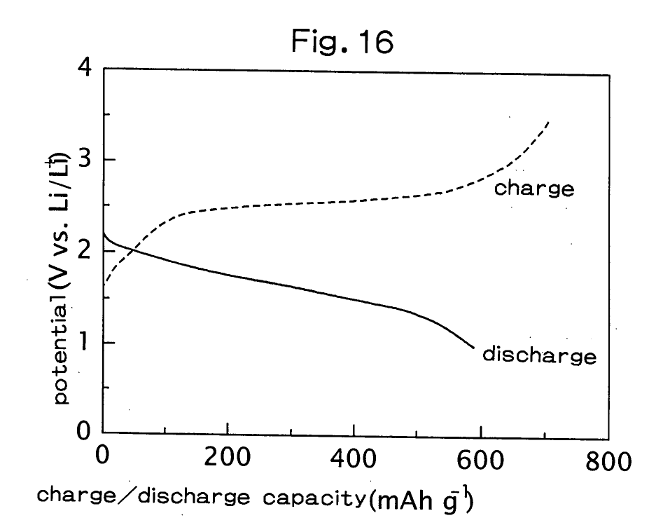

Further, the test cell of Inventive Example 7 was discharged to a discharge cutoff potential of 1.0 V (vs. Li/Li⁺) at a discharge current of 0.13 mA/cm², and then charged to a charge cutoff potential of 3.5 V (vs. Li/Li⁺) at a charge current of 0.13 mA/cm², to examine the initial charge-discharge characteristics. The results are given in FIG. 16. Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in the test cell of Example 7, the initial specific discharge capacity per 1 g of elemental sulfur was 588 mAh/g, and the specific discharge capacity was markedly increased, compared with that of LiCoO₂ used in a general positive electrode.

### Inventive Example 8

In Inventive Example 8, the same non-aqueous electrolyte as that in the above-mentioned Inventive Example 7 was used. Otherwise, the test cell of Example 8 was prepared as in the case of the above-mentioned Inventive Example 2.

### Evaluation 8

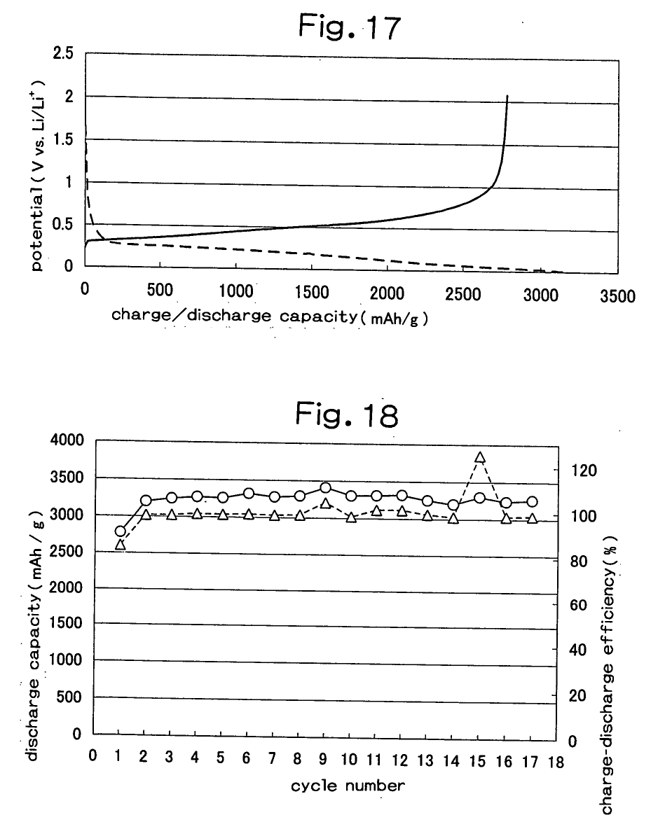

The test cell of Inventive Example 8 was charged to a charge cutoff potential of 0.0 V (vs. Li/Li⁺) at a charge current of 0.05 mA/cm², and then discharged to a discharge cutoff potential of 2.0 V (vs. Li/Li⁺) at a discharge current of 0.05 mA/cm², to examine the initial charge-discharge characteristics. The results are given in FIG. 17. Note that the solid line represents a discharge curve showing the relationship between the potential and the capacity per 1 g of active material during charging, and the broken line represents a charge curve showing the relationship between the potential and capacity per 1 g of active material during discharging.

As a result, in the test cell of Example 8, the initial specific charge and discharge capacities per 1 g of active material were 3282 mAh/g and 2778 mAh/g, respectively. The specific charge/discharge capacity was markedly increased, compared with that of a carbon material used in a general positive electrode. Moreover, the reversible reaction of the silicon thin film was also proved.

Further, with the test cell of Inventive Example 8, the operation of charging the cell to a charge cutoff potential of 0.0 V (vs. Li/Li⁺) at a charge current of 0.05 mA/cm², and then discharging the cell to a discharge cutoff potential of 2.0 V (vs. Li/Li⁺) at a discharge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the above-mentioned equation. In FIG. 18, the white circle and solid line represent the discharge capacity (mAh/g) in each cycle, and the triangle and broken line represent the charge-discharge efficiency (%) in each cycle.

As a result, in the test cell of Inventive Example 8, the specific discharge capacities in the third cycle and thereafter were kept constant at approximately 3243 mAh/g, and the charge-discharge efficiencies were also kept constant at approximately 98%.

### Inventive Example 9

In Inventive Example 9, a non-aqueous electrolyte including a lithium salt, or LiN(CF₃SO₂)₂ dissolved at a concentration of 0.5 mol/l in a mixture of 50% by volume of 1, 3-dioxolane and 50% by volume of trimethylpropylammonium bis (trifluoromethylsulfonyl)imide ((CH₃)₃N⁺(C₃H₇)N⁻(SO₂CF₃)₂) was used. Otherwise, the test cell of Inventive Example 9 was prepared as in the case of the above-mentioned Inventive Example 1.

### Evaluation 9

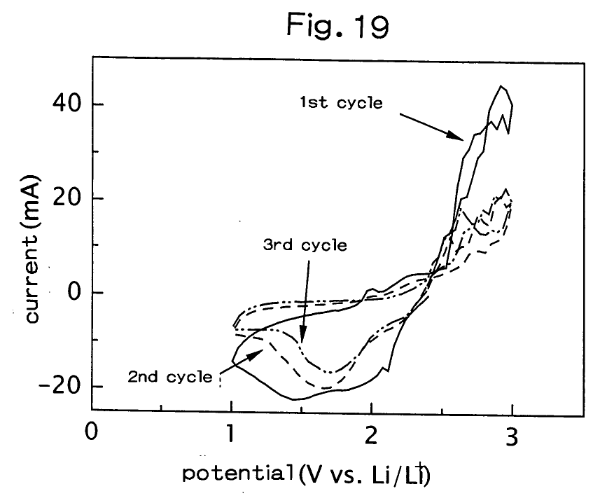

Using the test cell of Inventive Example 9 thus prepared, the potential of the active electrode 11 relative to the reference electrode 13 was scanned starting at an initial potential of 2.4 V (vs. Li/Li⁺) in a reduction direction, and then in an oxidation direction for three cycles, at a scan rate of 1.0 mV/s in a scan range of 1.0 to 3.0 V (vs. Li/Li⁺), to measure the cyclic voltammetry in each cycle. The results are given in FIG. 19.

As a result, in the case of the test cell of Inventive Example 9, a reduction current began to flow at around 2.3 V or lower (vs. Li/Li⁺) during scanning in the reduction direction, and so it is presumed that elemental sulfur was reduced. In addition, there was an oxidation peak around 2.6 V (vs. Li/Li⁺) during scanning in the oxidation direction, and so it is presumed that the above-mentioned reduced elemental sulfur was oxidized at around this potential. The same results were obtained also in the second cycle and thereafter. It is therefore presumed that the reversible reaction of elemental sulfur was carried out.

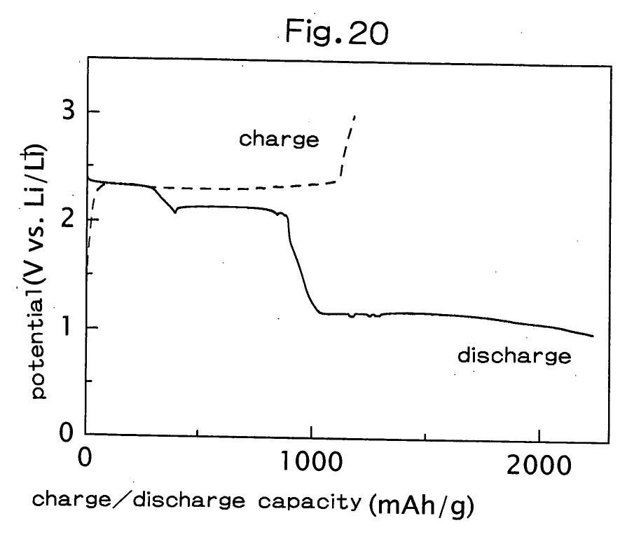

The test cell of Inventive Example 9 was discharged to adischarge cutoff potential of 1.0 V (vs. Li/Li⁺) at adischarge current of 0.13 mA/cm², and then charged to a charge cutoff potential of 3.0V (vs. Li/Li⁺) at acharge current of 0.13mA/cm², to examine the initial charge-discharge characteristics. The results are given in FIG. 20. Note that the solid line represents a discharge curve showing the relationship between the potential and the capacity per 1 g of elemental sulfur during discharging, and the broken line represents a charge curve showing the relationship between the potential and capacity per 1 g of elemental sulfur during charging.

As a result, in the test cell of Inventive Example 9, the initial specific discharge capacity per 1 g of elemental sulfur was 2230 mAh/g. The specific discharge capacity was markedly increased, compared with that of LiCoO₂ used in a general positive electrode. Further, the mixture of 1,3-dioxolane and trimethylpropylammonium bis (trifluoromethylsulfonyl)imide ((CH₃)₃N⁺(C₃H₇)N⁻(SO₂CF₃)₂) increases the specific capacities at around 2.0 V or higher during discharging, compared with that obtained using 1,3-dioxolane alone, and the specific discharge capacity was also greater than that obtained using trimethylpropylammonium bis (trifluoromethylsulfonyl)imide ((CH₃)₃N⁺(C₃H₇)N⁻(SO₂CF₃)₂) alone as an electrolyte, as shown in Inventive Example 1.

### Inventive Example 10

In Inventive Example 10, the same non-aqueous electrolyte as that in the above-mentioned Inventive Example 9 was used. Otherwise, the test cell in Inventive Example 10 was prepared as in the case of the test cell of the above-mentioned Inventive Example 2.

### Evaluation 10

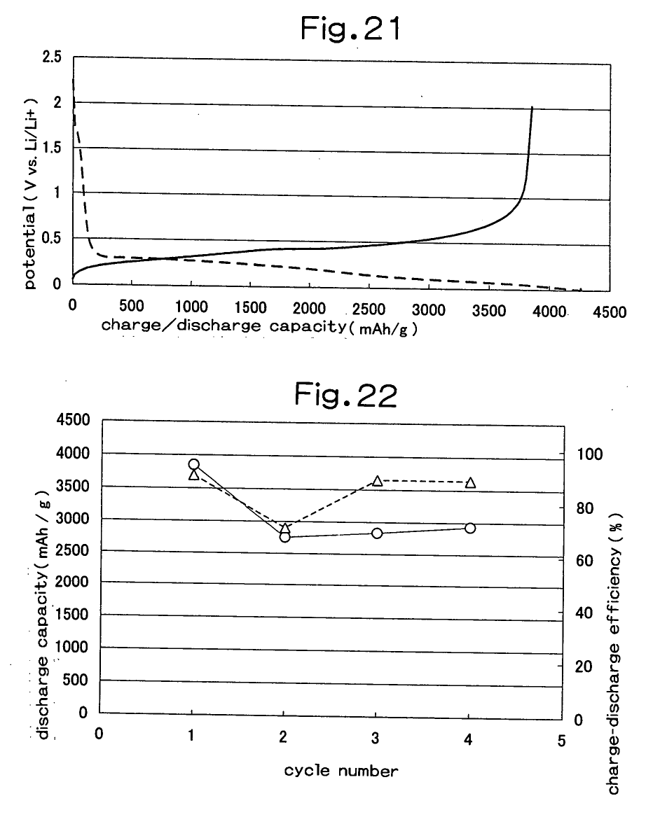

The test cell of Inventive Example 10 was charged to a charge cutoff potential of 0.0 V (vs. Li/Li⁺) at a charge current of 0.05 mA/cm², and then discharged to a discharge cutoff potential of 2.0 V (vs. Li/Li⁺) at a discharge current of 0.05 mA/cm², to examine the initial charge-discharge characteristics. The results are given in FIG. 21. Note that the solid line represents a discharge curve showing the relationship between the potential and the capacity per 1 g of active material during charging, and the broken line represents a charge curve showing the relationship between the potential and the capacity per 1 g of active material during discharging.

As a result, in the test cell of Inventive Example 10, the initial specific charge and discharge capacities per 1 g of active material were approximately 4260 mAh/g and 3852 mAh/g, respectively. The specific charge/discharge capacity was markedly increased, compared with that of a carbon material used in a general positive electrode. The reversible reaction of the silicon thin film was also proved.

Further, with this test cell of Inventive Example 10, the operation of charging the cell to a charge cutoff potential of 0.0 V (vs. Li/Li⁺) at a charge current of 0.05 mA/cm², and then discharging the cell to a discharge cutoff potential of 2.0 V (vs. Li/Li⁺) at a discharge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the above-mentioned equation. In FIG. 22, the white circle and solid line represent the discharge capacity (mAh/g) in each cycle, and the triangle and broken line represent the charge-discharge efficiency (%) in each cycle.

As a result, in the test cell in Inventive Example 10, the specific discharge capacities in the third cycle and thereafter were kept constant at approximately 2837 mAh/g, and the charge/discharge efficiencies were also kept constant at approximately 89%.

### Inventive Example 11

In Inventive Example 11, a non-aqueous electrolyte including a lithium salt, LiN(CF₃SO₂)₂ dissolved at a concentration of 0.5 mol/l in a mixture of 25% by volume of 1,3-dioxolane and 75% by volume of trimethylpropylammonium bis(trifluoromethylsulfonyl)imide ((CH₃)₃N⁺(C₃H₇)N⁻(SO₂CF₃) 2) was used. Otherwise, the test cell of Inventive Example 11 was prepared as in the case of the above-mentioned Inventive Example 1.

### Evaluation 11

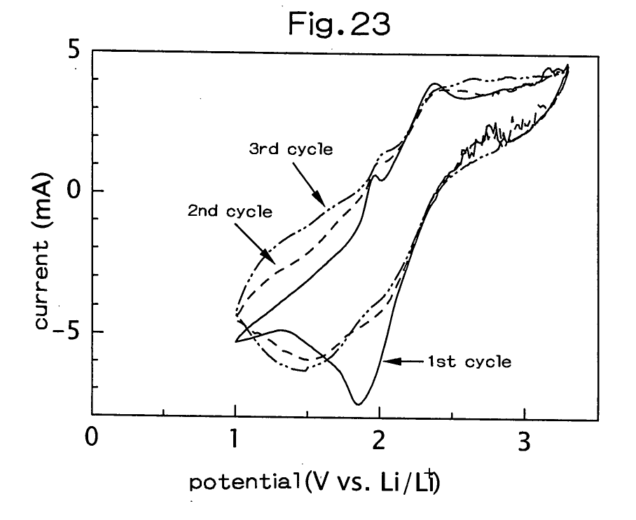

Using the test cell of Inventive Example 11 thus prepared, the potential of the active electrode 11 relative to the reference electrode 13 was scanned starting at an initial potential of 2.4 V (vs. Li/Li⁺) in a reduction direction, and then in an oxidation direction for three cycles, at a scan rate of 1.0 mV/s in a scan range of 1.0 to 3.3 V (vs. Li/Li⁺), to measure the cyclic voltammetry in each cycle. The results are given in FIG. 23.

As a result, in the case of the test cell of Inventive Example 11, a reduction peak appeared at around 1.9 V (vs. Li/Li⁺) during scanning in the reduction direction, and so it is presumed that the elemental sulfur was reduced. In addition, an oxidation peak appeared around 2.4 V (vs. Li/Li⁺) during scanning in the oxidation direction, and so it is presumed that the above-mentioned reduced elemental sulfur was oxidized at around this potential. Also in the second cycle and thereafter, there were reduction peaks at around 1.5 V (vs. Li/Li⁺) during scanning in the reduction direction, and oxidation peaks at around 2.4 V (vs. Li/Li⁺) during scanning in the oxidation direction. It is therefore presumed that the reversible reaction of elemental sulfur was carried out.

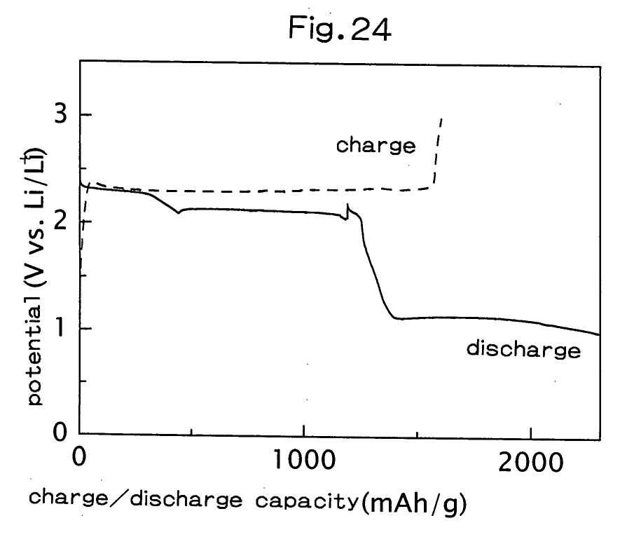

Further, the test cell of Inventive Example 11 was discharged to a discharge cutoff potential of 1.0 V (vs. Li/Li⁺) at a discharge current of 0.13 mA/cm², and then charged to a charge cutoff potential of 3.0 V (vs. Li/Li⁺) at a charge current of 0.13 mA/cm², to examine the initial charge-discharge characteristics. The results are given in FIG. 24. Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in the test cell of Inventive Example 11, the initial specific discharge capacity per 1 g of elemental sulfur was 2291 mAh/g, and the specific discharge capacity was markedly increased, compared with that of LiCoO₂ used in a general positive electrode. Further, the mixture of 1,3-dioxolane and trimethylpropylammonium bis(trifluoromethylsulfonyl)imide ((CH₃)₃N⁺(C₃H₇)N⁻(SO₂CF₃)₂) increased the capacity at around 2.0 V or higher (vs. Li/Li⁺) during discharging, compared with that obtained using 1,3-dioxolane alone as an electrolyte, as shown in Comparative Example 3 below, and the specific discharge capacity was also greater than that obtained using trimethylpropylammonium bis(trifluoromethylsulfonyl)imide ((CH₃)₃N⁺(C₃H₇)N⁻(SO₂CF₃)₂) alone as an electrolyte, as shown in Inventive Example 1.

### Inventive Example 12

In Inventive Example 12, the same non-aqueous electrolyte as that in the above-mentioned Inventive Example 11 was used. Otherwise, the test cell of Inventive Example 12 was prepared as in the case of the above-mentioned Inventive Example 2.

### Evaluation 12

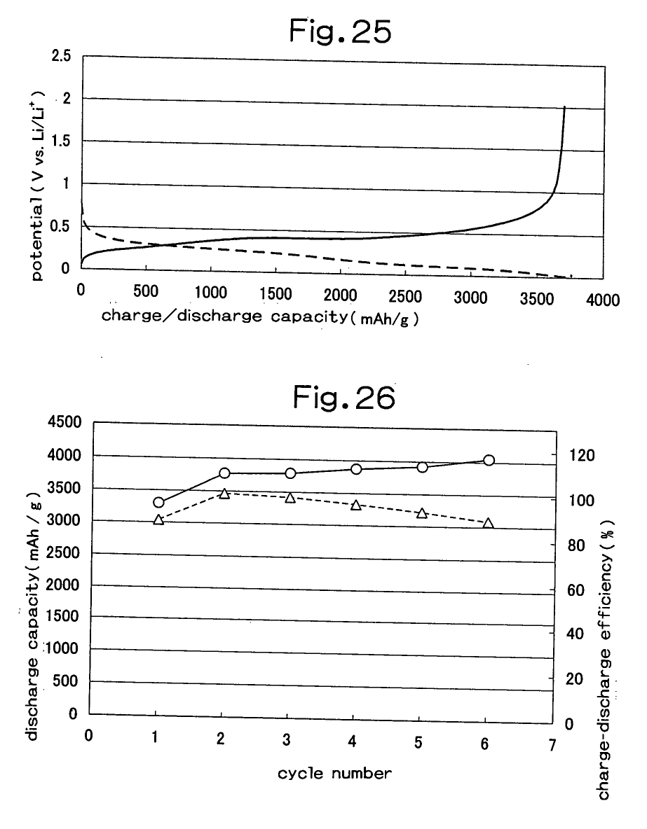

The test cell of Inventive Example 12 was charged to a charge cutoff potential of 0.0 V (vs. Li/Li⁺) at a charge current of 0.05 mA/cm², and then discharged to a discharge cutoff potential of 2.0 V (vs. Li/Li⁺) at a discharge current of 0.05 mA/cm², to examine the initial charge-discharge characteristics. The results are given in FIG. 25. Note that the solid line represents a discharge curve showing the relationship between the potential and the capacity per 1 g of active material during charging, and the broken line represents a charge curve showing the relationship between the potential and the capacity per 1 g of active material during discharging.

As a result, in this test cell of Inventive Example 12, the initial specific charge and discharge capacities per 1 g of active material were approximately 3756 mAh/g and 3300 mAh/g, respectively. The specific charge/discharge capacity was markedly increased, compared with that of a carbon material used in a general negative electrode. The reversible reaction of the silicon thin film was also proved.

Further, with the test cell of Inventive Example 12, the operation of charging the cell to a charge cutoff potential of 0.0 V (vs. Li/Li⁺) at a charge current of 0.05 mA/cm², and then discharging the cell to a discharge cutoff potential of 2.0 V (vs. Li/Li⁺) at a discharge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the above-mentioned equation. In FIG. 26, the solid line and white circle represent the discharge capacity (mAh/g) in each cycle, and the broken line and triangle represent the charge-discharge efficiency (%) in each cycle.

As a result, in this test cell of Inventive Example 12, the specific discharge capacities in the third cycle and thereafter were kept constant at approximately 3789 mAh/g, and the charge-discharge efficiencies were also kept constant at approximately 99%.

### Comparative Example 3

In Comparative Example 3, a non-aqueous electrolyte including a lithium salt, LiN(CF₃SO₂)₂ dissolved at a concentration of 0.5 mol/l in 1,3-dioxolane was used. Otherwise, the test cell of Comparative Example 3 was prepared as in the case of the above-mentioned Inventive Example 1.

### Evaluation 13

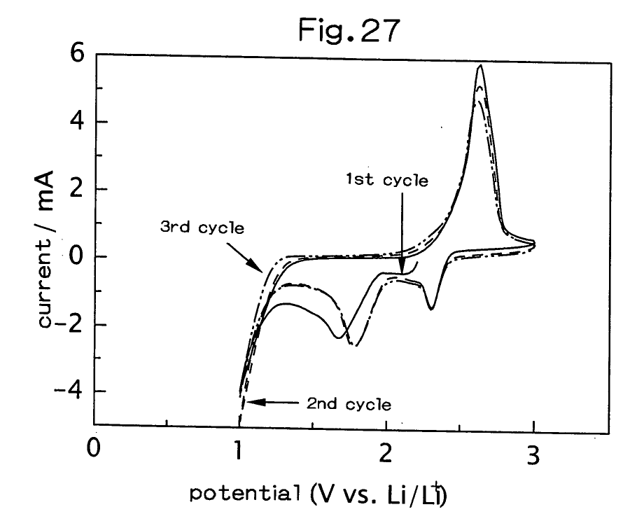

Using the test cell of Comparative Example 3 thus prepared, the potential of the active electrode 11 relative to the reference electrode 13 was scanned starting at an initial potential of 2.2 V (vs. Li/Li⁺) in a reduction direction, and then in an oxidation direction for three cycles, at a scan rate of 1.0 mV/s in a scan range of 1.0 to 3.0 V (vs. Li/Li⁺), to measure the cyclic voltammetry in each cycle. The results are given in FIG. 27.

As a result, in the case of the test cell of Comparative Example 3, a reduction peak appeared at around 1.8 V (vs. Li/Li⁺) during scanning in the reduction direction, and a large reduction current flowed at around 1.2 V or lower (vs. Li/Li⁺). It is thus presumed that the elemental sulfur was reduced. In addition, there was an oxidation peak at around 2.6 V (vs. Li/Li⁺) during scanning in the oxidation direction, and so it is presumed that the above-mentioned reduced elemental sulfur was oxidized at around this potential.

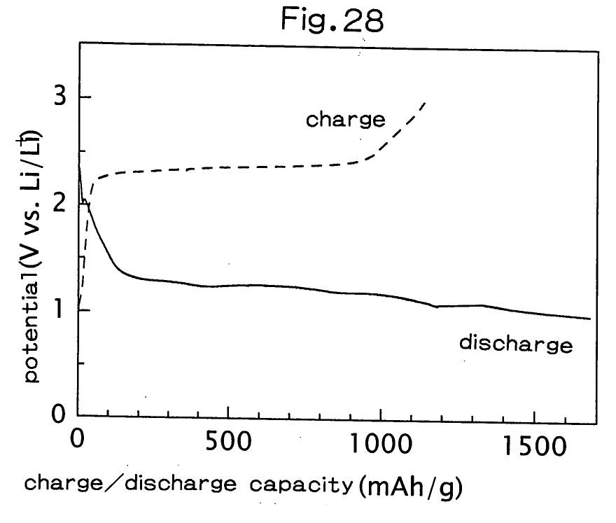

The test cell of Comparative Example 3 was discharged to a discharge cutoff potential of 1.0 V (vs. Li/Li⁺) at a discharge current of 0.13 mA/cm², and then charged to a charge cutoff potential of 3.0 V (vs. Li/Li⁺) at a charge current of 0.13 mA/cm², to examine the initial charge-discharge characteristics. The results are given in FIG. 28.

Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in this test cell of Comparative Example 3, the initial specific discharge capacity per 1 g of elemental sulfur was 1677 mAh/g. The specific discharge capacity was markedly increased, compared with that of LiCoO₂ used in a general positive electrode, while the discharge potential was as low as approximately 1.2 V (vs. Li/Li⁺).

### Evaluation 14

The mixture of trimethylpropylammonium bis(trifluoromethylsulfonyl)imide ((CH₃)₃N⁺(C₃H₇)N⁻(SO₂CF₃)₂) and 1,3-dioxolane has reduced viscosity in the electrolyte, compared with the electrolyte containing only trimethylpropylammonium bis(trifluoromethylsulfonyl)imide ((CH₃)₃N⁺(C₃H₇)N⁻(SO₂CF₃)₂) Accordingly, the mixture is preferable for use as an electrolyte.

### Evaluation 15

The results of Inventive Examples 1, 9, 11, and Comparative Example 3 show that in the use of a positive electrode including elemental sulfur, it is more preferable to mix trimethylpropylammonium bis(trifluoromethylsulfonyl)imide ((CH₃)₃N⁺(C₃H₇)N⁻(SO₂CF₃)₂) with 1,3-dioxolane than to use 1,3-dioxolane or trimethylpropylammonium bis(trifluoromethylsulfonyl)imide ((CH₃)₃N⁺(C₃H₇)N⁻(SO₂CF₃)₂) alone, when comparing the specific discharge capacities at around 2 V or higher (vs. Li/Li⁺) during discharging. The 1,3-dioxolane may be set in the range of 0.1 to 99.9% by volume. Preferably, the ratio of 1,3-dioxolane may be set in the range of 0.1 to 50% by volume, more preferably in the range of 0.1 to 25% by volume.

### Inventive Example 13

In Inventive Example 13, a non-aqueous electrolyte including a lithium salt, LiN(CF₃SO₂)₂ dissolved at a concentration of 0.5 mol/l in a mixture of 50% by volume of tetrahydrofuran and 50% by volume of trimethylpropylammonium bis(trifluoromethylsulfonyl)imide ((CH₃)₃N⁺(C₃H₇)N⁻(SO₂CF₃)₂) was used. Otherwise, the test cell of Inventive Example 13 was prepared as in the case of the above-mentioned Inventive Example 1.

### Evaluation 16

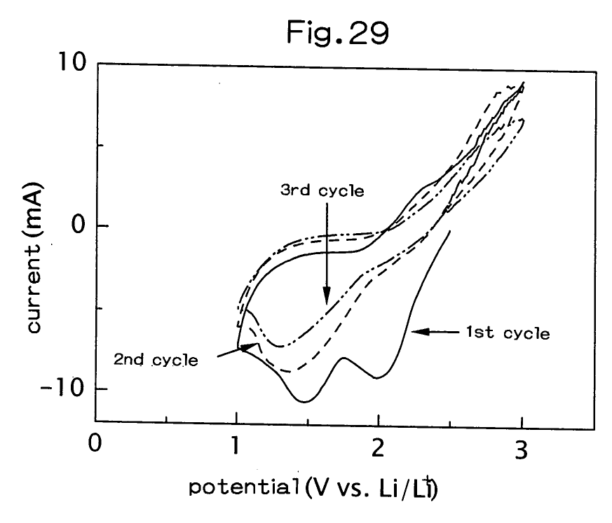

Using the test cell of Inventive Example 13 thus prepared, the potential of the active electrode 11 relative to the reference electrode 13 was scanned starting at an initial potential of 2.5 V (vs. Li/Li⁺) in a reduction direction, and then in an oxidation direction for three cycles, at a scan rate of 1.0 mV/s in a scan range of 1.0 to 3.0 V (vs. Li/Li⁺), to measure the cyclic voltammetry in each cycle. The results are given in FIG. 29.

As a result, in the case of the test cell of Inventive Example 13, reduction peaks appeared at around 2.0 V (vs. Li/Li⁺) and 1.5 V (vs. Li/Li⁺) during scanning in the reduction direction, and so it is presumed that the elemental sulfur was reduced. In addition, an oxidation current flowed at around 2.2 V or higher (vs. Li/Li⁺) during scanning in the oxidation direction, and it is presumed that the above-mentioned reduced elemental sulfur was oxidized at this potential range.

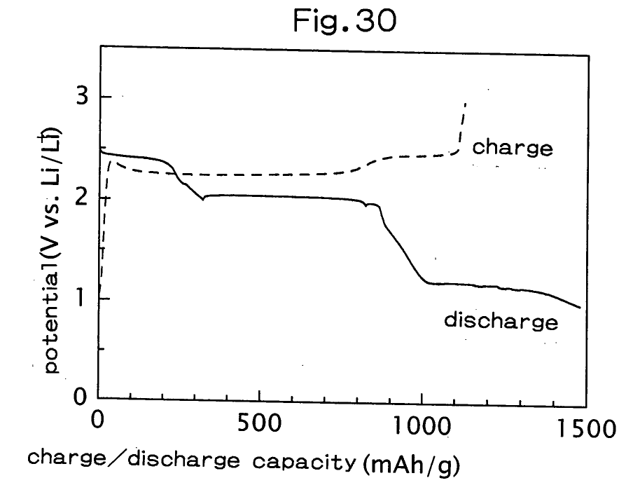

Further, the test cell of Inventive Example 12 was discharged to a discharge cutoff potential of 1.0 V (vs. Li/Li⁺) at a discharge current of 0.13 mA/cm², and then charged to a charge cutoff potential of 3.0 V (vs. Li/Li⁺) at a charge current of 0.13 mA/cm², to examine the initial charge-discharge characteristics. The results are given in FIG. 30. Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in this test cell of Inventive Example 13, the initial specific discharge capacity per 1 g of elemental sulfur was 1479 mAh/g. The specific discharge capacity was markedly increased, compared with that of LiCoO₂ used in a general positive electrode. In addition, the mixture of tetrahydrofuran and trimethylpropylammonium bis(trifluoromethylsulfonyl)imide ((CH₃)₃N⁺(C₃H₇)N⁻(SO₂CF₃)₂) increased the capacity at around 2.0 V or higher (vs. Li/Li⁺) during discharging, compared with that obtained using tetrahydrofuran alone as an electrolyte, as shown in Comparative Example 4 below, and the specific discharge capacity was also greater than that obtained using trimethylpropylammonium bis(trifluoromethylsulfonyl)imide ((CH₃)₃N⁺(C₃H₇)N⁻(SO₂CF₃)₂) alone as an electrolyte, as shown in Inventive Example 1.

### Inventive Example 14

In Inventive Example 14, the same non-aqueous electrolyte as that in the above-mentioned Inventive Example 13 was used. Otherwise, the test cell of Inventive Example 14 was prepared as in the case of the above-mentioned Inventive Example 2.

### Evaluation 17

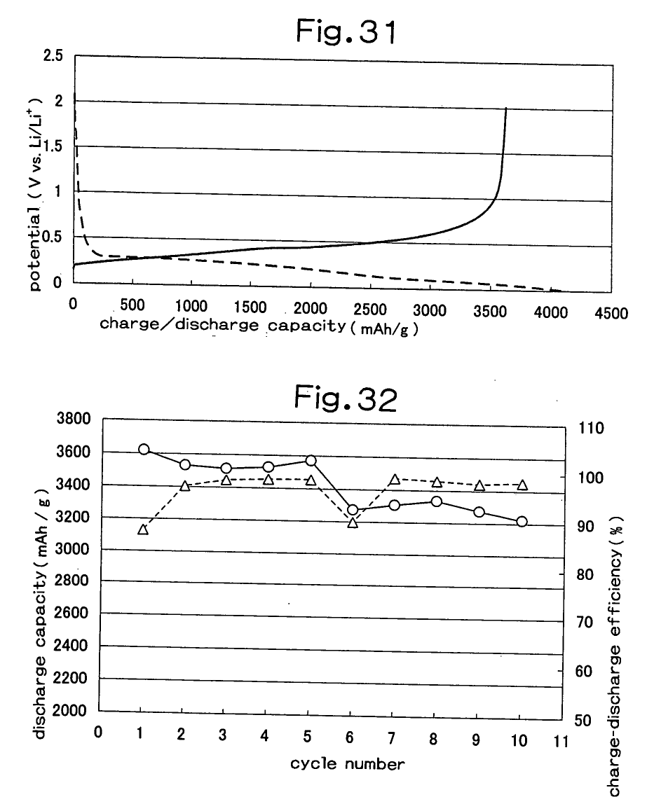

The test cell of Inventive Example 14 was charged to a charge cutoff potential of 0.0 V (vs. Li/Li⁺) at a charge current of 0.05 mA/cm², and then discharged to a discharge cutoff potential of 2.0 V (vs. Li/Li⁺) at a discharge current of 0.05 mA/cm², to examine the initial charge-discharge characteristics. The results are given in FIG. 31. Note that the solid line represents a discharge curve showing the relationship between the potential and the capacity per 1 g of active material during charging, and the broken line represents a charge curve showing the relationship between the potential and the capacity per 1 g of active material during discharging.

As a result, in this test cell of Inventive Example 14, the initial specific charge and discharge capacities per 1 g of active material were 4126mAh/g and 3619mAh/g, respectively. The specific charge/discharge capacity was markedly increased, compared with that of a carbon material used in a general negative electrode. The reversible reaction of the silicon thin film was also proved.

Further, with the test cell of Inventive Example 14, the operation of charging the cell to a charge cutoff potential of 0.0 V (vs. Li/Li⁺) at a charge current of 0.05 mA/cm², and then discharging the cell to a discharge cutoff potential of 2.0 V (vs. Li/Li⁺) at a discharge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the above-mentioned equation. In FIG. 32, the white circle and solid line represent the discharge capacity (mAh/g) in each cycle, and the triangle and broken line represent the charge-discharge efficiency (%) in each cycle.

As a result, in this test cell of Inventive Example 14, the specific discharge capacities in the third cycle and thereafter were kept constant at approximately 3515 mAh/g, and the charge-discharge efficiencies were also kept constant at approximately 98%.

### Inventive Example 15

In Inventive Example 15, a non-aqueous electrolyte including a lithium salt, LiN(CF₃SO₂)₂ dissolved at a concentration of 0.5 mol/l in a mixture of 25% by volume of tetrahydrofuran and 75% by volume of trimethylpropylammonium bis(trifluoromethylsulfonyl)imide ((CH₃)₃N⁺(C₃H₇)N⁻(SO₂CF₃)₂) was used. Otherwise, the test cell of Inventive Example 15 was prepared as in the case of the above-mentioned Inventive Example 1.

### Evaluation 18

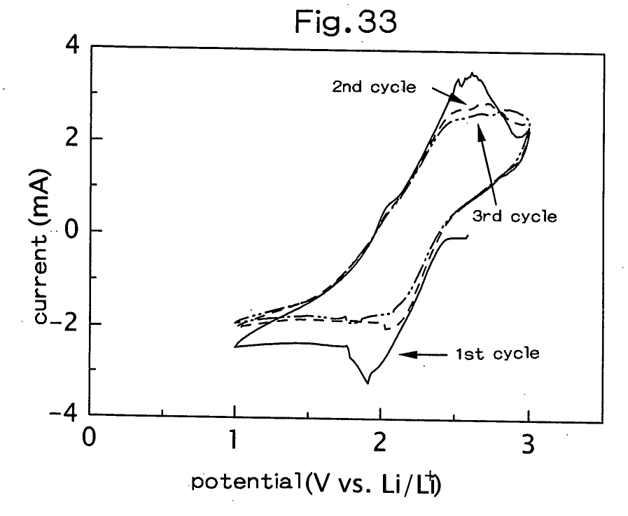

Using the test cell of Inventive Example 15 thus prepared, the potential of the active electrode 11 relative to the reference electrode 13 was scanned starting at an initial potential of 2.6 V (vs. Li/Li⁺) in a reduction direction, and then in an oxidation direction for three cycles, at a scan rate of 1.0 mV/s in a scan range of 1.0 to 3.0 V (vs. Li/Li⁺), to measure the cyclic voltammetry in each cycle. The results are given in FIG. 33.

As a result, in the case of the test cell of Inventive Example 15, a reduction current flowed at around 2.4 V or lower (vs. Li/Li⁺) during scanning in the reduction direction, and so it is presumed that elemental sulfur was reduced. In addition, an oxidation peak appeared at around 2.5 V (vs. Li/Li⁺) during scanning in the oxidation direction, and so it is presumed that the above-mentioned reduced elemental sulfur was oxidized at around this potential.

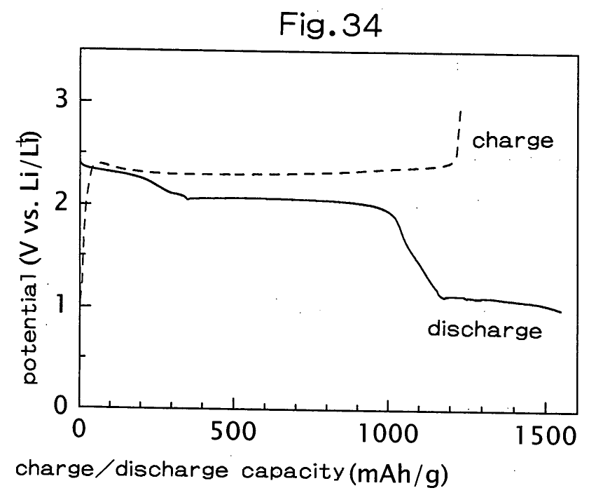

The test cell of Inventive Example 15 was discharged to a discharge cutoff potential of 1.0 V (vs. Li/Li⁺) at a discharge current of 0.13 mA/cm², and then charged to a charge cutoff potential of 3.0V (vs. Li/Li⁺) at acharge current of 0.13mA/cm², to examine the initial charge-discharge characteristics. The results are given in FIG. 34. Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in this test cell of Inventive Example 14, the initial specific discharge capacity per 1 g of elemental sulfur was 1547 mAh/g. The specific discharge capacity was markedly increased, compared with that of LiCoO₂ used in a general positive electrode. Further, the mixture of tetrahydrofuran and trimethylpropylammonium bis(trifluoromethylsulfonyl)imide ((CH₃)₃N⁺(C₃H,)N⁻(SO₂CF₃)₂) increased the capacity at around 2.0 V or higher (vs. Li/Li⁺) during discharging, compared with that obtained using tetrahydrofuran alone as an electrolyte, as shown in Comparative Example 4 below, and the specific discharge capacity was also greater than that obtained using trimethylpropylammonium bis(trifluoromethylsulfonyl)imide ((CH₃)₃N⁺(C₃H₇)N⁻(SO₂CF₃)₂) alone as an electrolyte, as shown in Inventive Example 1.

### Inventive Example 16

In Inventive Example 16, the same non-aqueous electrolyte as that in the above-mentioned Inventive Example 15 was used. Otherwise, the test cell of Inventive Example 16 was prepared as in the case of the above-mentioned Inventive Example 2.

### Evaluation 19

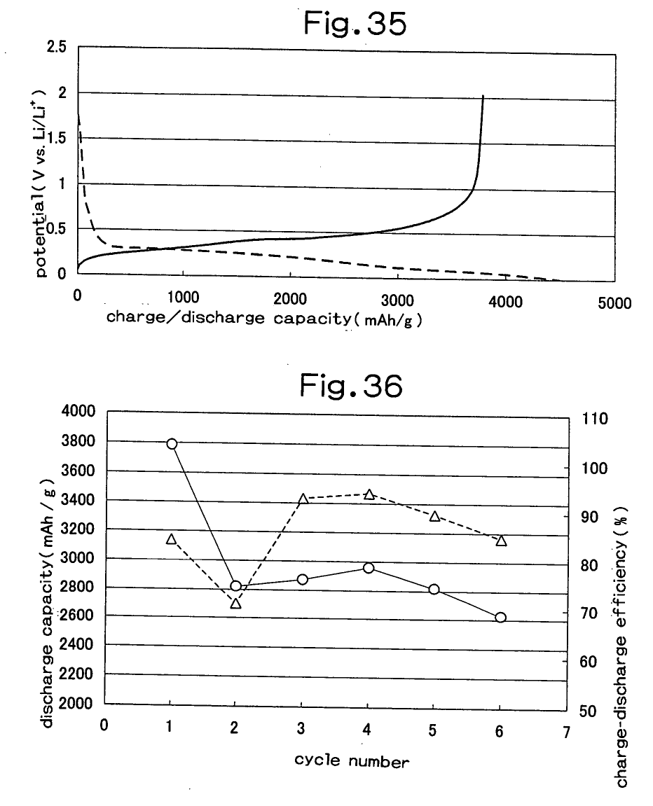

The test cell of Inventive Example 16 was charged to a charge cutoff potential of 0.0 V (vs. Li/Li⁺) at a charge current of 0.05 mA/cm², and then discharged to a discharge cutoff potential of 2.0 V (vs. Li/Li⁺) at a discharge current of 0.05 mA/cm², to examine the initial charge-discharge characteristics. The results are given in FIG. 35. Note that the solid line represents a discharge curve showing the relationship between the potential and the capacity per 1 g of active material during charging, and the broken line represents a charge curve showing the relationship between the potential and the capacity per 1 g of active material during discharging.

As a result, in this test cell of Inventive Example 16, the initial specific charge and discharge capacities per 1 g of active material were approximately 4495 mAh/g and 3786 mAh/g, respectively. The specific charge/discharge capacity was markedly increased, compared with that of a carbon material used in a general negative electrode. The reversible reaction of the silicon thin film was also proved.

Further, with the test cell of Inventive Example 16, the operation of charging the cell to a charge cutoff potential of 0.0 V (vs. Li/Li⁺) at a charge current of 0.05 mA/cm², and then discharging the cell to a discharge cutoff potential of 2.0 V (vs. Li/Li⁺) at a discharge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the above-mentioned equation. In FIG. 36, the white circle and solid line represent the discharge capacity (mAh/g) in each cycle, and the triangle and broken line represent the charge-discharge efficiency (%) in each cycle.

As a result, in this test cell of Inventive Example 16, the specific discharge capacities in the third cycle and thereafter were kept constant at approximately 2873 mAh/g, and the charge-discharge efficiencies were also kept constant at approximately 93%.

### Comparative Example 4

In Comparative Example 4, a non-aqueous electrolyte including a lithium salt, LiN(CF₃SO₂)₂ dissolved at a concentration of 0.5 mol/l in tetrahydrofuran was used. Otherwise, the test cell of Comparative Example 4 was prepared as in the case of the above-mentioned Inventive Example 1.

### Evaluation 20

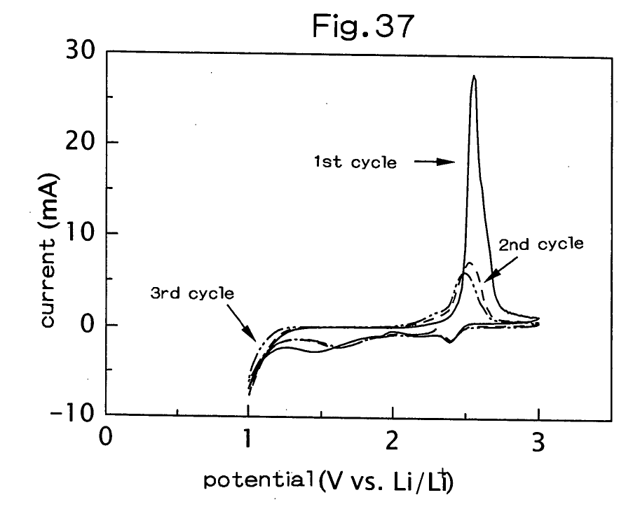

Using the test cell of Comparative Example 4 thus prepared, the potential of the active electrode 11 relative to the reference electrode 13 was scanned starting at an initial potential of 2.3 V (vs. Li/Li⁺) in a reduction direction, and then in an oxidation direction for three cycles, at a scan rate of 1.0 mV/s in a scan range of 1.0 to 3.0 V (vs. Li/Li⁺), to measure the cyclic voltammetry in each cycle. The results are given in FIG. 37.

As a result, in the case of the test cell of Comparative Example 4, a reduction peak appeared at around 1.6 V (vs. Li/Li⁺), and a large reduction current flowed at around 1.2 V or lower (vs. Li/Li⁺) during scanning in the reduction direction, and so it is presumed that elemental sulfur was reduced. In addition, there was an oxidation peak at around 2.5 V (vs. Li/Li⁺) during scanning in the oxidation direction, and it is presumed that the above-mentioned reduced elemental sulfur was oxidized at around this potential.

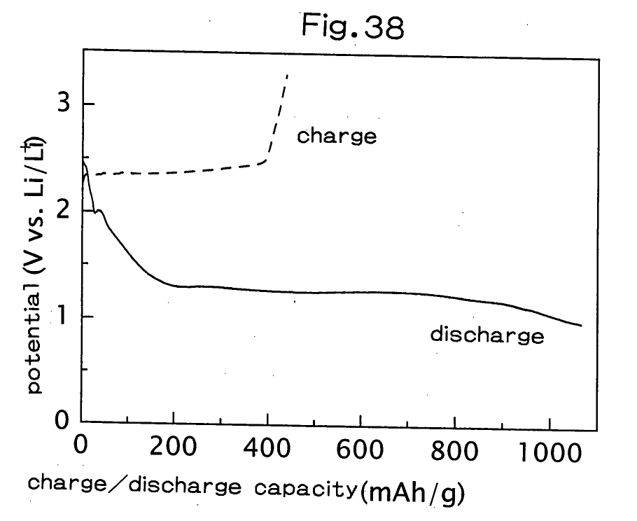

Further, the test cell of Comparative Example 4 was discharged to a discharge cutoff potential of 1.0 V (vs. Li/Li⁺) at a discharge current of 0.13 mA/cm², and then charged to a charge cutoff potential of 3.3 V (vs. Li/Li⁺) at a charge current of 0.13 mA/cm², to examine the initial charge-discharge characteristics. The results are given in FIG. 38. Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in this test cell of Comparative Example 4, the initial specific discharge capacity per 1 g of elemental sulfur was 1065 mAh/g. The specific discharge capacity was markedly increased, compared with that of LiCoO₂ used in a general positive electrode, while the discharge potential was as low as approximately 1.2 V (vs. Li/Li⁺).

### Evaluation 21

The mixture of trimethylpropylammonium bis(trifluoromethylsulfonyl)imide ((CH₃)₃N⁺(C₃H₇)N⁻(SO₂CF₃)₂) and tetrahydrofuran has reduced viscosity in the electrolyte, compared with the electrolyte containing only trimethylpropylammonium bis(trifluoromethylsulfonyl)imide ((CH₃)₃N⁺(C₃H₇)N⁻(SO₂CF₃)₂). Accordingly, the mixture is preferable for use as an electrolyte.

### Evaluation 22

Further, the results of Inventive Examples 1, 13, 17, and Comparative Example 4 show that in the use of a positive electrode including elemental sulfur, it is preferable to mix trimethylpropylammonium bis(trifluoromethylsulfonyl)imide ((CH₃)₃N⁺(C₃H₇)N⁻(SO₂CF₃)₂) with tetrahydrofuran than to use trimethylpropylammonium bis(trifluoromethylsulfonyl)imide ((CH₃)₃N⁺(C₃H₇)N⁻(SO₂CF₃) 2) or tetrahydrofuran alone, when comparing the specific discharge capacities in plateaus at around 2.0 V or higher (vs. Li/Li⁺) in the discharge characteristics. The tetrahydrofuran may be set in the range of 0.1 to 99.9% by volume. Preferably, the ratio of tetrahydrofuran may be set in the range of 0.1 to 50% by volume, more preferably, in the range of 0.1 to 25% by volume.

### Inventive Example 17

In Inventive Example 17, a non-aqueous electrolyte including a lithium salt, LiN(CF₃SO₂)₂ dissolved at a concentration of 0.5 mol/l in a mixture of 50% by volume of 1,2-dimethoxyethane and 50% by volume of trimethrlpropylammonium bis(trifluoromethylsulfonyl)imide ((CH₃)₃N⁺(C₃H₇)N⁻(SO₂CF₃)₂) was used. Otherwise, the test cell of Inventive Example 17 was prepared as in the case of the above-mentioned Inventive Example 1.

### Evaluation 23

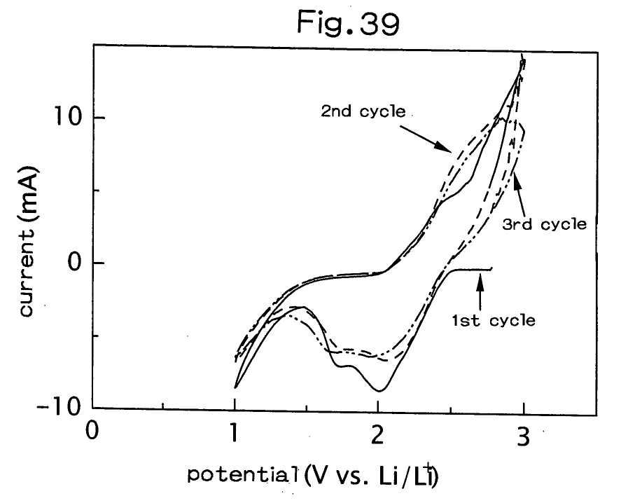

Using the test cell of Inventive Example 17 thus prepared, the potential of the active electrode 11 relative to the reference electrode 13 was scanned starting at an initial potential of 2.8 V (vs. Li/Li⁺) in a reduction direction, and then in an oxidation direction for three cycles, at a scan rate of 1.0 mV/s in a scan range of 1.0 to 3.0 V (vs. Li/Li⁺), to measure the cyclic voltammetry in each cycle. The results are given in FIG. 39.

As a result, in the case of the test cell of Inventive Example 17, a reduction peak appeared at around 2.0 V (vs. Li/Li⁺) during scanning in the reduction direction, and so it ispresumedthattheelementalsulfurwasreduced. Inaddition, an oxidation current flowed at around 2.2 V or higher (vs. Li/Li⁺) during scanning in the oxidation direction, and so it is presumed that the above-mentioned reduced elemental sulfur was oxidized at this potential range.

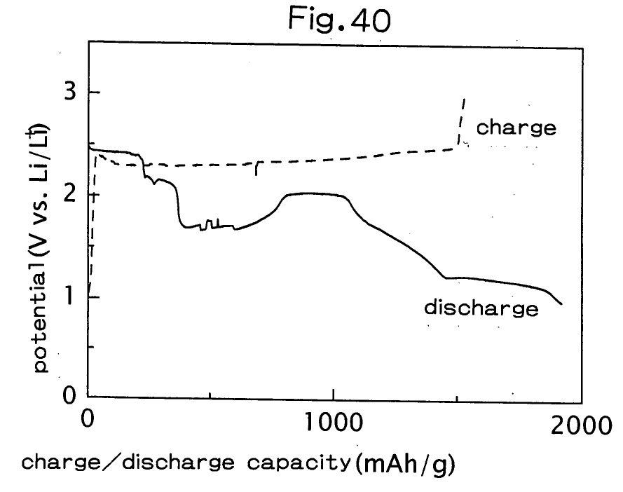

Further, the test cell of Inventive Example 17 was discharged to a discharge cutoff potential of 1.0 V (vs. Li/Li⁺) at a discharge current of 0.13 mA/cm², and then charged to a charge cutoff potential of 3.0 V (vs. Li/Li⁺) at a charge current of 0.13 mA/cm²; to examine the initial charge-discharge characteristics. The results are given in FIG. 40. Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in this test cell of Inventive Example 17, the initial specific discharge capacity per 1 g of elemental sulfur was 1919 mAh/g. The specific discharge capacity was markedly increased, compared with that of LiCoO₂ used in a general positive electrode. Further, the mixture of tetrahydrofuran and trimethylpropylammonium bis(trifluoromethylsulfonyl)imide ((CH₃)₃N⁺(C₃H₇)N⁻(SO₂CF₃)₂) increased the specific capacity at around 1.5 V or higher (vs. Li/Li⁺) during discharging, compared with that obtained using tetrahydrofuran alone as an electrolyte, as shown in Comparative Example 5, and the specific discharge capacity was also greater than that obtained using trimethylpropylammonium bis(trifluoromethylsulfonyl)imide ((CH₃)₃N⁺(C₃H₇)N⁻(SO₂CF₃)₂) alone as an electrolyte, as shown in Inventive Example 1.

### Inventive Example 18

In Inventive Example 18, the same non-aqueous electrolyte as that in the above-mentioned Inventive Example 17 was used. Otherwise, the test cell of Inventive Example 18 was prepared as in the case of the above-mentioned Inventive Example 2.

### Evaluation 24

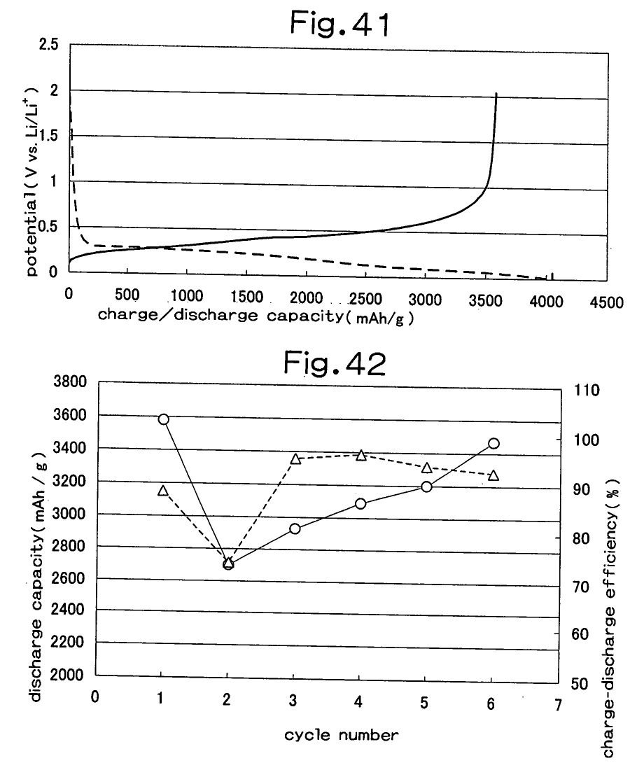

The test cell of Inventive Example 18 was charged to a charge cutoff potential of 0.0 V (vs. Li/Li⁺) at a charge current of 0.05 mA/cm², and then discharged to a discharge cutoff potential of 2.0 V (vs. Li/Li⁺) at a discharge current of 0.05 mA/cm², to examine the initial charge-discharge characteristics. The results are given in FIG. 41. Note that the solid line represents a discharge curve showing the relationship between the potential and the capacity per 1 g of active material during charging, and the broken line represents a charge curve showing the relationship between the potential and the capacity per 1 g of active material during discharging.

As a result, in this test cell of Inventive Example 18, the initial specific charge and discharge capacities per 1 g of active material were approximately 4050 mAh/g and 3580 mAh/g, respectively. The specific charge/discharge capacity was markedly increased, compared with that of a carbon material used in a negative electrode. The reversible reaction of the silicon thin film was also proved.

Further, with the test cell of Inventive Example 18, the operation of charging the cell to a charge cutoff potential of 0.0 V (vs. Li/Li⁺) at a charge current of 0.05 mA/cm², and then discharging the cell to a discharge cutoff potential of 2.0 V (vs. Li/Li⁺) at a discharge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the above-mentioned equation. In FIG. 42, the white circle and solid line represent the discharge capacity (mAh/g) in each cycle, and the triangle and broken line represent the charge-discharge efficiency (%) in each cycle.

As a result, in this test cell of Inventive Example 18, the specific discharge capacities in the third cycle and thereafter were kept constant at approximately 2930 mAh/g, and the charge-discharge efficiencies were also kept constant at approximately 95%.

### Inventive Example 19

In Inventive Example 19, a non-aqueous electrolyte including a lithium salt, LiN(CF₃SO₂)₂ dissolved at a concentration of 0.5 mol/l in a mixture of 25% by volume of 1,2-dimethoxyethane and 75% by volume of trimethylpropylammonium bis(trifluoromethylsulfonyl)imide ((CH₃)₃N⁺(C₃H₇)N⁻(SO₂CF₃)₂) was used. Otherwise, the test cell of Inventive Example 19 was prepared as in the case of the above-mentioned Inventive Example 1.

### Evaluation 25

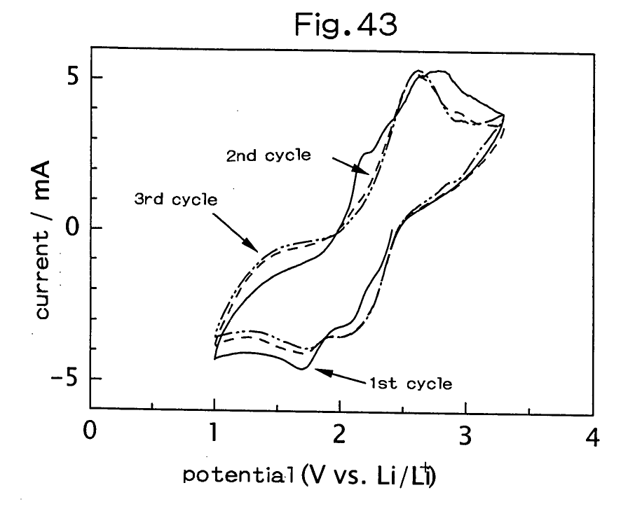

Using the test cell of Inventive Example 19 thus prepared, the potential of the active electrode 11 relative to the reference electrode 13 was scanned starting at an initial potential of 2.4 V (vs. Li/Li⁺) in a reduction direction, and then in an oxidation direction for three cycles, at a scan rate of 1.0 mV/s in a scan range of 1.0 to 3.3 V (vs. Li/Li⁺), to measure the cyclic voltammetry in each cycle. The results are given in FIG. 43.

As a result, in the case of the test cell of Inventive Example 19, a reduction current flowed at around 2.4 V or lower (vs. Li/Li⁺) during scanning in the reduction direction, and so it is presumed that elemental sulfur was reduced. In addition, an oxidation peak appeared at around 2.5 V (vs. Li/Li⁺) during scanning in the oxidation direction, and so it is presumed that the above-mentioned reduced elemental sulfur was oxidized at this potential range.

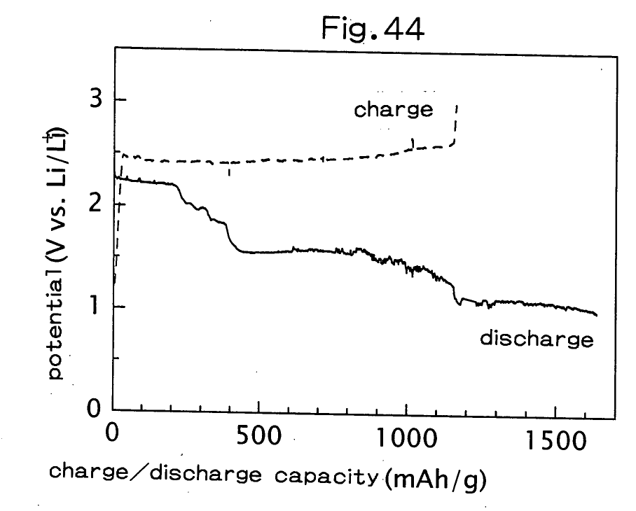

Further, the test cell of Inventive Example 19 was discharged to a discharge cutoff potential of 1.0 V (vs. Li/Li⁺) at a discharge current of 0.13 mA/cm², and then charged to a charge cutoff potential of 3.0 V (vs. Li/Li⁺) at a charge current of 0.13 mA/cm², to examine the initial charge-discharge characteristics. The results are given in FIG. 44. Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in this test cell of Inventive Example 19, the initial specific discharge capacity per 1 g of elemental sulfur was 1636 mAh/g. The specific discharge capacity was markedly increased, compared with that of LiCoO₂ used in a general positive electrode. Further, the mixture of 1,2-dimethoxyethane and trimethylpropylammonium bis(trifluoromethylsulfonyl)imide ((CH₃)₃N⁺(C₃H₇)N⁻(SO₂CF₃)₂) increased the specific capacity at around 1.5 V or higher (vs. Li/Li⁺) during discharging, compared with that obtained using 1,2-dimethoxyethane alone as an electrolyte, as shown in Comparative Example 5 below, and the specific discharge capacity was also greater than that obtained using trimethylpropylammonium bis(trifluoromethylsulfonyl)imide ((CH₃)₃N⁺(C₃H₇)N⁻(SO₂CF₃)₂) alone as an electrolyte, as shown in Inventive Example 1.

### Inventive Example 20

In Inventive Example 20, the same non-aqueous electrolyte as that in the above-mentioned Inventive Example 19 was used. Otherwise, the test cell of Inventive Example 20 was prepared as in the case of the above-mentioned Inventive Example 2.

### Evaluation 26

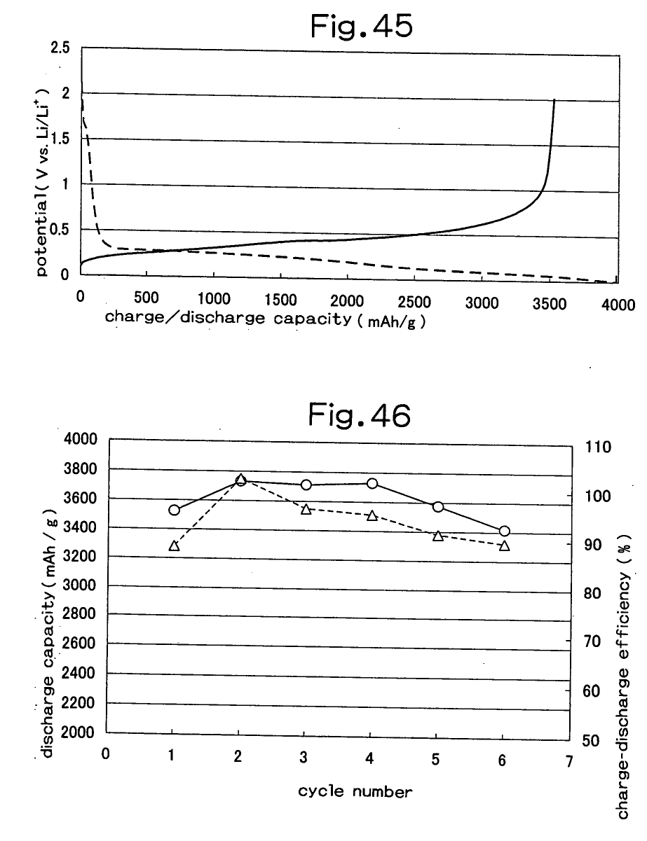

The test cell of Inventive Example 20 was charged to a charge cutoff potential of 0.0 V (vs. Li/Li⁺) at a charge current of 0.05 mA/cm², and then discharged to a discharge cutoff potential of 2.0 V (vs. Li/Li⁺) at a discharge current of 0.05 mA/cm², to examine the initial charge-discharge characteristics. The results are given in FIG. 45. Note that the solid line represents a discharge curve showing the relationship between the potential and the capacity per 1 g of active material during charging, and the broken line represents a charge curve showing the relationship between the potential and the capacity per 1 g of active material during discharging.

As a result, in this test cell of Inventive Example 20, the initial specific charge and discharge capacities per 1 g of active material were approximately 3984 mAh/g and 3526 mAh/g, respectively. The specific charge/discharge capacity was markedly increased, compared with that of a carbon material used in a general negative electrode. The reversible reaction of the silicon thin film was also proved.

Further, with the test cell of Inventive Example 20, the operation of charging the cell to a charge cutoff potential of 0.0 V (vs. Li/Li⁺) at a charge current of 0.05 mA/cm², and then discharging the cell to a discharge cutoff potential of 2.0 V (vs. Li/Li⁺) at a discharge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the above-mentioned equation. In FIG. 46, the white circle and solid line represent the discharge capacity (mAh/g) in each cycle, and the triangle and broken line represent the charge-discharge efficiency (%) in each cycle.

As a result, in this test cell of Inventive Example 20, the specific discharge capacities in the third cycle and thereafter were kept constant at approximately 3713 mAh/g, and the charge-discharge efficiencies were also kept constant at approximately 96%.

### Comparative Example 5

In Comparative Example 5, a non-aqueous electrolyte including a lithium salt, LiN(CF₃SO₂)₂ dissolved at a concentration of 0.5 mol/l in 1,2-dimethoxyethane was used. Otherwise, the test cell of Comparative Example 5 was prepared as in the case of the above-mentioned Inventive Example 1.

### Evaluation 27

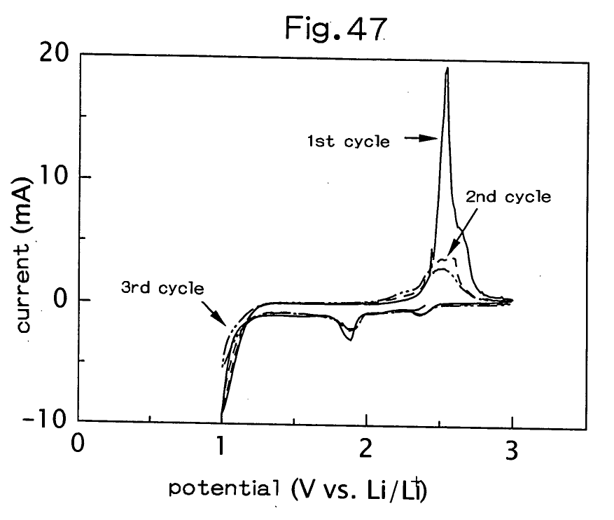

Using the test cell of Comparative Example 5 thus prepared, the potential of the active electrode 11 relative to the reference electrode 13 was scanned starting at an initial potential of 2.4 V (vs. Li/Li⁺) in a reduction direction, and then in an oxidation direction for three cycles, at a scan rate of 1.0 mV/s in a scan range of 1.0 to 3.0 V (vs. Li/Li⁺), to measure the cyclic voltammetry in each cycle. The results are given in FIG. 47.

As a result, in the case of the test cell of Comparative Example 5, a reduction peak appeared at around 1.8 V (vs. Li/Li⁺) and a large reduction current flowed at around 1.2 V or lower (vs. Li/Li⁺) during scanning in the reduction direction, and so it is presumed that elemental sulfur was reduced. In addition, there was an oxidation peak at around 2.5 V (vs. Li/Li⁺) during scanning in the oxidation direction, and so it is presumed that the above-mentioned reduced elemental sulfur was oxidized at around this potential.

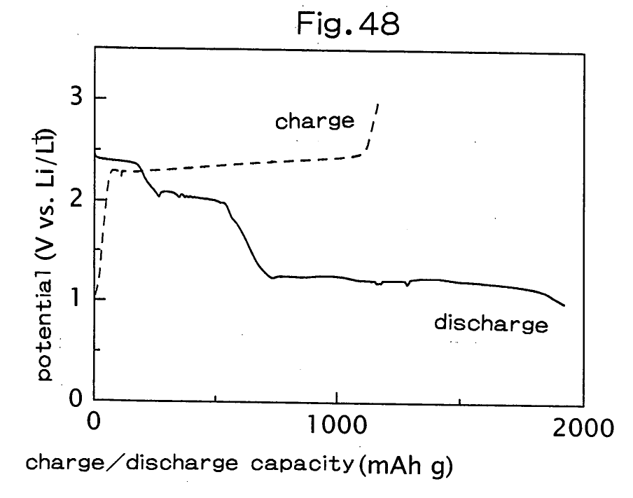

Further, the test cell of Comparative Example 5 was discharged to a discharge cutoff potential of 1.0 V (vs. Li/Li⁺) at a discharge current of 0.13 mA/cm², and then charged to a charge cutoff potential of 3.0 V (vs. Li/Li⁺) at a charge current of 0.13 mA/cm², to examine the initial charge-discharge characteristics. The results are given in FIG. 48. Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

As a result, in this test cell of Comparative Example 5, the initial specific discharge capacity per 1 g of elemental sulfur was 1921 mAh/g. The specific discharge capacity was markedly increased, compared with that of LiCoO₂ used in a general positive electrode. However, the capacity at around 2 V or higher (vs. Li/Li⁺) was small in the discharge characteristics, and most of the discharge potentials were as low as approximately 1.2 V (vs. Li/Li⁺).

### Evaluation 28

The mixture of trimethylpropylammonium bis(trifluoromethylsulfonyl)imide ((CH₃)₃N⁺(C₃H₇)N⁻(SO₂CF₃)₂) and 1,2-dimethoxyethane has reduced viscosity in the electrolyte, compared with the electrolyte containing only trimethylpropylammonium bis(trifluoromethylsulfonyl)imide ((CH₃)₃N⁺(C₃H₇)N⁻(SO₂CF₃)₂). Accordingly, the mixture is preferable for use as an electrolyte.

### Evaluation 29

Moreover, the results of Inventive Examples 1, 17, 19, and Comparative Example 5 show that in the use of a positive electrode including elemental sulfur, it is more preferable to mix trimethylpropylammonium bis(trifluoromethylsulfonyl)imide ((CH₃)₃N⁺(C₃H₇)N⁻(SO₂CF₃)₂) with 1,2-dimethoxyethane than to use trimethylpropylammonium bis(trifluoromethylsulfonyl)imide ((CH₃)₃N⁺(C₃H₇)N⁻(SO₂CF₃)₂) or 1,2-dimethoxyethane alone, when comparing the specific discharge capacities at around 1.5 V or higher (vs. Li/Li⁺) in the discharge characteristics. The 1,2-dimethoxyethane may be set in the range of 0.1 to 99.9% by volume. Preferably, the ratio of 1,2-dimethoxyethane may be set in the range of 0.1 to 50% by volume, more preferably, in the range of 0.1 to 25% by volume.

In each of the following Inventive Examples 21, 22, a test cell using a positive electrode including elemental sulfur and a negative electrode including a silicon material was prepared, and the charge/discharge characteristics were measured. Table 3 summarizes the compositions of test cell of Inventive Examples 21, 22.

TABLE 3

| | positive | | | |
|---|---|---|---|---|
| | electrode | negative electrode | solute | non-aqueous electrolyte |
| Inventive | sulfur | amorphous | LiN(CF₃SO₂)₂ | room temperature |
| example 21 | | silicon thin | | molten salt 1: |
| | | film | | cyclic ether 1 (quaternary |
| | | | | ammonium salt) = 90:10 |
| Inventive | sulfur | amorphous | LiN(CF₃SO₂)₂ | room temperature |
| example 22 | | silicon thin | | molten salt 1: |
| | | film | | cyclic ether 1 (quaternary |
| | | | | ammonium salt) = 80:20 |

### Inventive Example 21

In Inventive Example 21, for a positive electrode, 60% by weight of elemental sulfur, 35% by weight of acetylene black as a conductive agent, and 1% by weight of carboxymethylcellulose were mixed and ground in a mortar for 30 minutes, and 4% by weight of styrene-butadiene rubber as a binder was added to the resultant material, and then the material was ground in a mortar for five minutes. The resultant material was applied to an aluminum foil having a rough surface by doctor blade technique, and formed into a 2.5 cm×2.5 cm size to be used as a positive electrode.

A negative electrode to be used was prepared as follows. An amorphous silicon thin film was formed by sputtering on a copper foil having an electrolytically treated surface, and formed into a 2.5 cm×2.5 cm size. A lithium salt, LiN(SO₂ CF₃ )₂ was dissolved at a concentration of 0.5 mol/l in a mixed solution including trimethylpropylammonium bis(trifluoromethylsulfonyl)imide ((CH₃)₃N⁺(C₃H₇)N⁻(SO₂CF₃)₂) and 4-methyl-1,3-dioxolane with a ratio of 90:10 (volume %). In this solution, the copper foil having the amorphous silicon film formed thereon was reacted with lithium metal to prepare SiLi_{4.4}.

Further, a non-aqueous electrolyte including a lithium salt, LiN(SO₂CF₃)₂ dissolved at a concentration of 0.5 mol/l in a mixed solution including trimethylpropylammonium bis(trifluoromethylsulfonyl)imide ((CH₃ )₃N⁺(C₃H₇)N⁻(SO₂CF₃)₂) and4-methyl-1,3-dioxolane with a ratio of 90:10 (volume %) was used.

Because the negative electrode of the test cell of Inventive Example 21 was composed of the amorphous silicon thin film, lithium (Li) was included with the amorphous silicon thin film to prepare the SiLi_{4.4}, and then the cell was charged/discharged.

### Evaluation 30

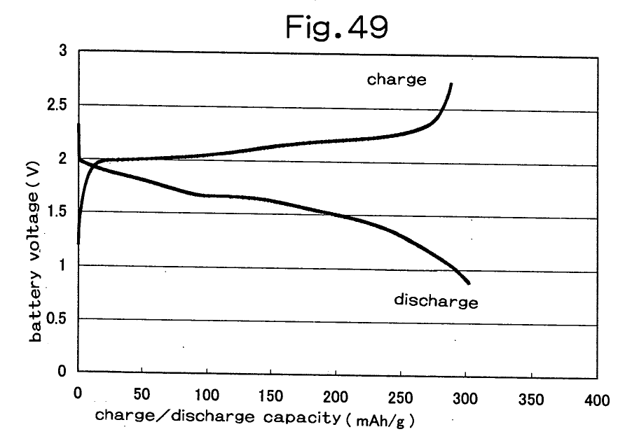

The test cell of Inventive Example 21 was discharged to a discharge cutoff potential of 1.5 V (vs. Li/Li⁺) at adischarge current of 0.05 mA/cm², and then charged to a charge cutoff potential of 2.8V (vs. Li/Li⁺) at acharge current of 0.05mA/cm², to examine the initial charge-discharge characteristics. The results are given in FIG. 49. In FIG. 49, the potentials during charging and discharging are the potentials of the positive and negative electrodes prepared above, and the relationship between the specific capacity and battery voltage per 1 g of the total weight of a mixture of the agents of the positive and negative electrodes is shown.

As a result, in this test cell of Inventive Example 21, the average voltage was 1.55 V, and the specific discharge capacity per 1 g of the total weight of the mixture of agents of the positive and negative electrodes was 302 mAh/g. The values suggest that this test cell had an energy density of 468 Wh/Kg, which is greater than that of the commercially available battery (approximately 200 Wh/Kg) using LiCoO₂ as a positive electrode active material.

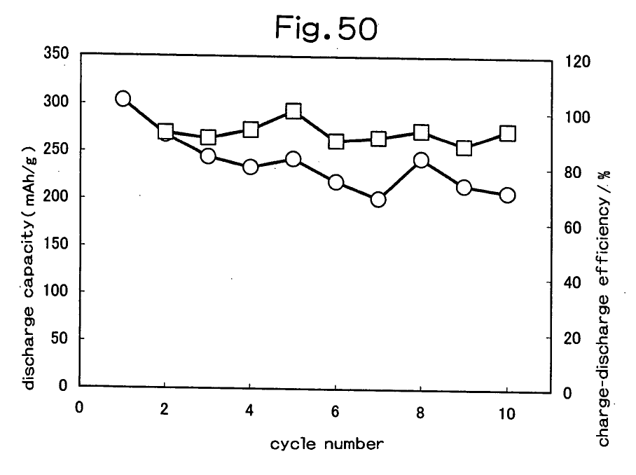

Further, with this test cell of Inventive Example 21, the operation of discharging the cell to a discharge cutoff potential of 1.5 V (vs. Li/Li⁺) at a discharge current of 0.05 mA/cm², and then charging the cell to a charge cutoff potential of 2.8 V (vs. Li/Li⁺) at a charge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the equation below. In FIG. 50, the white circle represents the discharge capacity (mAh/g) in each cycle, and the square represents the charge-discharge efficiency (%) in each cycle.

Charge/discharge efficiency=(Q_{b}/Qₐ)×100

In this test cell of Inventive Example 21, the average voltage was 1.59 V, and the specific discharge capacity per 1 g of the total weight of the mixture of agents of the positive and negative electrodes was 207 mAh/g during the tenth cycle. The values suggest that the test cell had an energy density of 329 Wh/Kg. Moreover, the charge-discharge efficiency was kept constant at approximately 90% or higher.

### Inventive Example 22

A positive electrode was prepared in a similar manner as in Inventive Example 21 , and a negative electrode to be used was prepared as follows. An amorphous silicon thin film was formed by sputtering on a copper foil having an electrolytically treated surface, and formed into a 2.5 cm×2.5 cm size. A lithium salt, LiN(SO₂CF₃ )₂ was dissolved at a concentration of 0.5 mol/l in a mixed solution including trimethylpropylammonium bis(trifluoromethylsulfonyl)imide ((CH₃)₃N⁺(C₃H₇)N⁻(SO₂CF₃)₂) and 4-methyl-1,3-dioxolane with a ratio of 80:20 (volume %). The copper foil having the amorphous silicon thin film formed thereon was reacted with lithium metal in this solution to prepare SiLi_{4.4}.

Further, a non-aqueous electrolyte including a lithium salt, LiN(SO₂CF₃ )2 dissolved at a concentration of 0.5 mol/l in a mixed solution including trimethylpropylammonium bis(trifluoromethylsulfonyl)imide ((CH₃)₃N⁺(C₃ H₇)N⁻(SO₂ CF₃)₂) and4-methyl-1,3-dioxolane with a ratio of 80:20 (volume %) was used.

Because the negative electrode of the test cell of Inventive Example 22 was composed of the amorphous silicon thin film, lithium (Li) was included with the amorphous silicon thin film to prepare the SiLi_{4.4}, and then the cell was charged/discharged.

### Evaluation 31

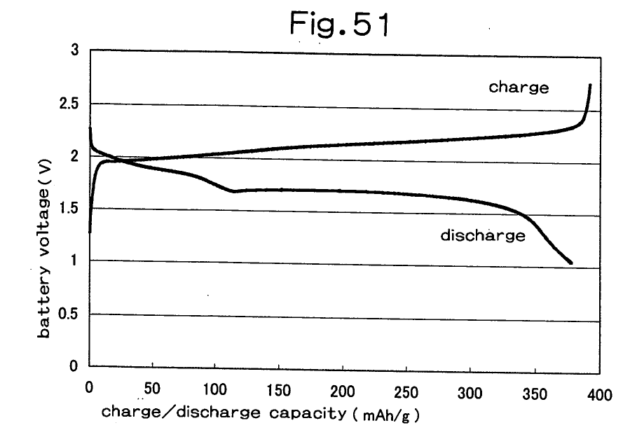

The test cell of Inventive Example 22 thus prepared was discharged to a discharge cutoff potential of 1.5 V (vs. Li/Li⁺) at a discharge current of 0.05 mA/cm², and then charged to a charge cutoff potential of 2.8 V (vs. Li/Li⁺) at a charge current of 0.05 mA/cm², to examine the initial charge-discharge characteristics. The results are given in FIG. 51. In FIG. 51, the potentials during charging and discharging are the potentials of the positive and negative electrodes prepared above, and the relationship between the specific capacity and battery voltage per 1 g of the total weight of a mixture of the agents of the positive and negative electrodes is shown.

As a result, in this test cell of Inventive Example 22, the average voltage was 1.69 V, and the specific discharge capacity per 1 g of the total weight of the mixture of agents of the positive and negative electrodes was 378 mAh/g. The values suggest that this test cell had an energy density of 639 Wh/Kg, which is greater than that of the commercially available battery (approximately 200 Wh/Kg) using LiCoO₂ as a positive electrode active material.

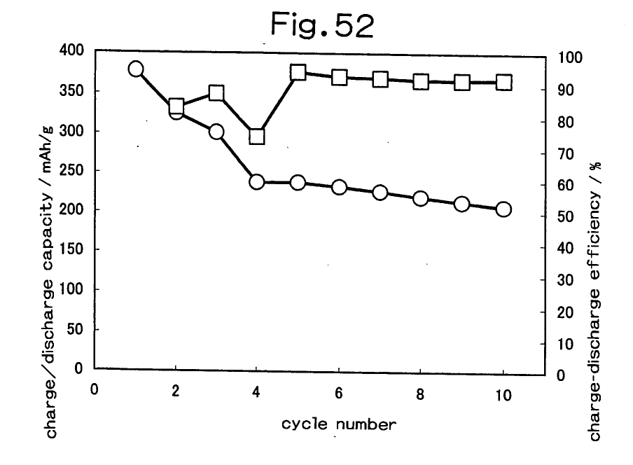

Further, with this test cell of Inventive Example 22, the operation of discharging the cell to a discharge cutoff potential of 1.5 V (vs. Li/Li⁺) at a discharge current of 0.05 mA/cm², and then charging the cell to a charge cutoff potential of 2.8 V (vs. Li/Li⁺) at a charge current of 0.05 mA/cm² was repeated, to measure the charge capacity Qₐ (mAh/g) and discharge capacity Q_{b} (mAh/g) in each cycle, and also find out the charge-discharge efficiency (%) in each cycle in accordance with the equation above. In FIG. 52, the white circle represents the discharge capacity (mAh/g) in each cycle, and the square represents the charge-discharge efficiency (%) in each cycle.

In this test cell of Inventive Example 22, the average voltage was 1.59 V, and the specific discharge capacity per 1 g of the total weight of the mixture of agents of the positive and negative electrodes was 213 mAh/g during the tenth cycle. The values suggest that the test cell had an energy density of 372 Wh/Kg. Moreover, the charge-discharge efficiency was kept constant at approximately 90% or higher.

### Evaluation Result

The results above show that increased specific discharge capacity can be obtained by mixing a quaternary ammonium salt, such as trimethylpropylammonium bis(trifluoromethylsulfonyl)imide ((CH₃ )₃ N⁺(C₃H₇)N⁻(SO₂ CF₃)₂), trimethyloctylammonium bis(trifluoromethylsulfonyl)imide ((CH₃)₃N⁺(C₈H₁₇)N⁻(SO₂CF₃)₂), trimethylallylammonium bis(trifluoromethylsulfonyl)imide ((CH₃)₃N⁺(Allyl)N⁻(SO₂CF₃)₂), trimethylhexylammonium bis(trifluoromethylsulfonyl)imide ((CH₃)₃N⁺(C₆H₁₃)N⁻(SO₂CF₃)₂), trimethylethylammonium 2,2,2-trifluoro-N-(trifluoromethylsulfonyl)acetamide ((CH₃)₃N⁺(C₂H₅)(CF₃CO)N⁻(SO₂CF₃)), trimethylallylammonium 2,2,2-trifluoro-N-(trifluoromethylsulfonyl)acetamide ((CH₃)₃N⁺(Allyl)(CF₃CO)N⁻(SO₂CF₃)), trimethylpropylammonium 2,2,2-trifluoro-N-(trifluoromethylsulfonyl)acetamide ((CH₃)₃N⁺(C₃H₇)(CF₃CO)N⁻(SO₂CF₃)), tetraethylammonium 2,2,2-trifluoro-N-(trifluoromethylsulfonyl)acetamide ((C₂H₅)₄N⁺(CF₃CO)N⁻(SO₂CF₃)), or triethylmethylammonium 2,2,2-trifluoro-N-(trifluoromethylsulfonyl)acetamide ((C₂H₅)₃N⁺(CH₃)(CF₃CO)N⁻(SO₂CF₃)); or a room temperature molten salt having a melting point of not higher than 60° C., such as an imidazolium salt illustrated by 1-ethyl-3-methylimidazolium bis(pentafluoroethylsulfonyl)imide ((C₂H₅)(C₃H₃N₂)⁺(CH₃)N⁻(SO₂C₂F₅)₂), 1-ethyl-3-methylimidazolium bis(trifluoromethylsulfonyl)imide ((C₂H₅)(C₃H₃N₂)⁺(CH₃)N⁻(SO₂CF₃)₂), 1-ethyl-3-methylimidazolium tetrafluoroborate ((C₂H₅)(C₃H₃N₂)⁺(CH₃)BF₄⁻), 1-ethyl-3-methylimidazolium pentafluoroborate ((C₂H₅)(C₃H₃N₂)⁺(CH₃)PF₆⁻) with at least one type of an organic solvent selected from fluorinated cyclic carbonates, such as trifluoropropylene carbonate, tetrafluoropropylene carbonate, and fluoroethyl carbonate; cyclic ethers, such as 1, 3-dioxolane, 2-methyl-1, 3-dioxolane, 4-methyl-1,3-dioxolane, tetrahydrofuran, 2-methyl tetrahydrofuran, propylene oxide, 1,2-butylene oxide, 1,4-dioxane, 1,3,5-trioxane, furan, 2-methylfuran, 1,8-cineole, and crown ether; or chain ethers, such as 1, 2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether. Needless to say, a mixture of at least two types of room temperature molten salts having a melting point of not higher than 60° C. may also be used.

### Example (2)

It will now be apparent from the citation of Examples that the non-aqueous electrolyte secondary battery according to the present invention having a positive electrode using elemental sulfur can be appropriately charged/discharged at room temperature, and has much increased energy density. It will be recognized that the following examples merely illustrate the practice of the non-aqueous electrolyte secondary battery in the present invention but are not intended to be limiting thereof. Suitable changes and modifications can be effected without departing the scope of the present invention.

In each of the following Inventive Example 23 and Comparative Example 6, thetest cell shown in FIG. 1 was prepared to evaluate the positive electrode including sulfur material.

As shown in FIG. 1, the non-aqueous electrolyte 14 was poured into the test cell vessel 10, and the working electrode 11, counter electrode 12, and reference electrode 13 were immersed in the non-aqueous electrolyte 14.

### Comparative Example 6

For a positive electrode, 75% by weight of sulfur powder with a purity of 99%, 20% by weight of ketchen black as a conductive agent, 4% by weight of styrene-butadiene rubber as a binder, and 1% by weight of carboxymethylcellulose as a thickener were mixed with the addition of water, and further mixed in a mortar to prepare slurry. The slurry was applied on an electrolytic aluminum foil by doctor blade technique, and cut into a 2 cm×2 cm size to make an electrode. The electrode was dried under vacuum at 50° C. to prepare the positive electrode.

A non-aqueous electrolyte including a lithium salt, LiN(CF₃SO₂)₂ dissolved at a concentration of 0.5 mol/l in a mixture of 1,3-dioxolane and trimethylpropylammonium bis(trifluoromethylsulfonyl)imide ((CH₃ )₃N⁺(C₃ H₇ )N⁻(SO₂ CF₃)₂) with a volume ratio of 10:90 was used.

Then, as shown in FIG. 1, the above-mentioned non-aqueous electrolyte 14 was poured into the test cell vessel 10, while the positive electrode was used as the working electrode 11, and lithium metal was used for each of the negative electrode as the counter electrode 12 and the reference electrode 13, to prepare a test cell of Comparative Example.

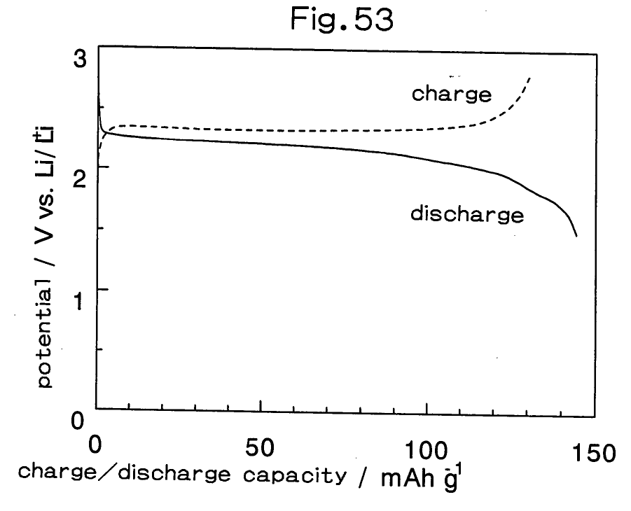

The test cell of Comparative Example was discharged to a discharge cutoff potential of 1.5 V (vs. Li/Li⁺) at a discharge current of 0.05 mA/cm², and then charged to a charge cutoff potential of 2.8V (vs. Li/Li⁺) at acharge current of 0.05mA/cm², to examine the initial charge-discharge characteristics. The results are given in FIG. 53.

Note that the solid line represents a discharge curve showing the relationship between the potential and the specific capacity per 1 g of elemental sulfur during discharging, and the broken line represents a charge curve showing the relationship between the potential and the specific capacity per 1 g of elemental sulfur during charging.

The initial discharge and charge specific capacities were 144 mAh/g, and 130 mAh/g, respectively. This suggests that the elemental sulfur was charged/discharged reversibly.

### Inventive Example 23

The test cell of Inventive Example 23 was prepared in a similar way as the test cell of Comparative Example. Further, in order to facilitate the impregnation of the positive electrode with the electrolyte, the test cell vessel 10 was held under a pressure of 28000 Pa (−55 cmhg with respect to atmospheric pressure) for 30 minutes.

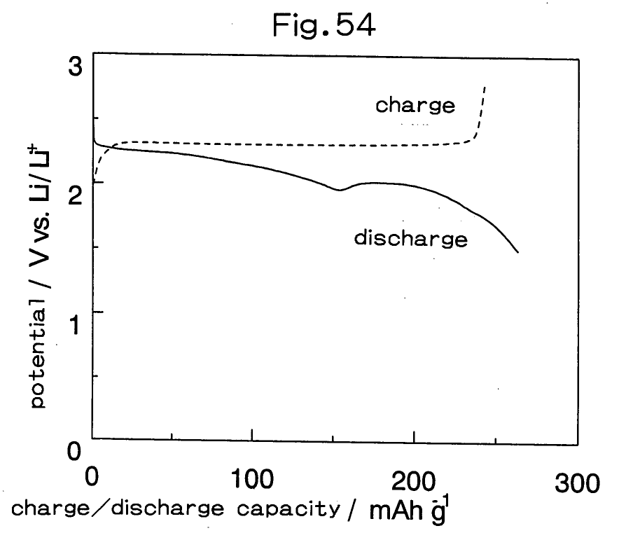

The test cell of Inventive Example 23 was discharged to a discharge cutof f potential of 1.5 V (vs. Li/Li⁺) at a discharge current of 0.05 mA/cm², and then charged to a charge cutoff potential of 2.8 V (vs. Li/Li⁺) at a charge current of 0.05 mA/cm², to examine the initial charge-discharge characteristics. The results are given in FIG. 54.

Note that the solid line represents a discharge curve showing the relationship between the potential and the capacity per 1 g of elemental sulfur during discharging, and the broken line represents a charge curve showing the relationship between the potential and the capacity per 1 g of elemental sulfur during charging.

The initial specif ic discharge and charge capacities were 263 mAh/g, and 243 mAh/g, respectively. This suggests that the elemental sulfur was charged/discharged reversibly. Moreover, in Inventive Example involving the process of impregnating the positive electrode with the electrolyte, both the specific discharge and charge capacities were increased, compared with those in Comparative Example without the process. The result shows that the positive electrode was impregnated with the non-aqueous electrolyte the positive electrode due to the process of impregnation, leading to the further increased specific charge/discharge capacity.

### Industrial Applicability

The non-aqueous electrolyte secondary battery according to the present invention is applicable to various power sources, including the power sources for portable equipment and vehicles.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A non-aqueous electrolyte secondary battery comprising a positive electrode, a negative electrode, and a non-aqueous electrolyte, wherein
said positive electrode includes elemental sulfur, and said negative electrode includes silicon that stores lithium.

2. The non-aqueous electrolyte secondary battery according to claim 1, wherein
said non-aqueous electrolyte includes a room temperature molten salt having a melting point of not higher than 60° C.

3. The non-aqueous electrolyte secondary battery according to claim 2, wherein
said room temperature molten salt includes at least one type selected from the group consisting of trimethylpropylammonium bis(trifluoromethylsulfonyl)imide, trimethylhexylammonium bis(trifluoromethylsulfonyl)imide, and triethylmethylammonium 2,2,2-trifluoro-N-(trifluoromethylsulfonyl)acetamide.

4. The non-aqueous electrolyte secondary battery according to claim 1, wherein
said non-aqueous electrolyte includes a quaternary ammonium salt.

5. The non-aqueous electrolyte secondary battery according to claim 4, wherein
said quaternary ammonium salt includes at least one type selected from the group consisting of trimethylpropylammonium bis(trifluoromethylsulfonyl)imide, trimethylhexylammonium bis(trifluoromethylsulfonyl)imide, and triethylmethylammonium 2,2,2-trifluoro-N-(trifluoromethylsulfonyl)acetamide.

6. The non-aqueous electrolyte secondary battery according to claim 2, wherein
said non-aqueous electrolyte further includes at least one type of solvent selected from the group consisting of cyclic ether, chain ether, and fluorinated carbonate.

7. The non-aqueous electrolyte secondary battery according to claim 6, wherein
said cyclic ether includes at least one type selected from the group consisting of 1,3-dioxolane and tetrahydrofuran; said chain ether preferably includes 1,2-dimethoxyethane; and said fluorinated carbonate includes at least one type selected from the group consisting of trifluoropropylene carbonate and tetrafluoropropylene carbonate.

8. The non-aqueous electrolyte secondary battery according to claim 1, wherein
said silicon is an amorphous silicon thin film or a microcrystalline silicon thin film.

9. The non-aqueous electrolyte secondary battery according to claim 1, wherein
a conductive agent is added to said positive electrode.

10. A non-aqueous electrolyte secondary battery comprising a positive electrode, a negative electrode, and a non-aqueous electrolyte, wherein
said negative electrode includes silicon that stores lithium, and
said non-aqueous electrolyte includes a room temperature molten salt having a melting point of not higher than 60° C. and a reduction product of elemental sulfur.

11. The non-aqueous electrolyte secondary battery according to claim 10, wherein
said positive electrode includes elemental sulfur.

12. The non-aqueous electrolyte secondary battery according to claim 10, wherein
said reduction product of elemental sulfur is obtained by reducing elemental sulfur in a room temperature molten salt having a melting point of not higher than 60° C. and an organic electrolyte.

13. The non-aqueous electrolyte secondary battery according to claim 10, wherein
said silicon is an amorphous silicon thin film or a microcrystalline silicon thin film.

14. The non-aqueous electrolyte secondary battery according to claim 10, wherein
said room temperature molten salt includes at least one type selected from the group consisting of trimethylpropylammonium bis(trifluoromethylsulfonyl)imide, trimethylhexylammonium bis(trifluoromethylsulfonyl)imide, and triethylmethylammonium 2,2,2-trifluoro-N-(trifluoromethylsulfonyl)acetamide.

15. The non-aqueous electrolyte secondary battery according to claim 10, wherein
a conductive agent is added to said positive electrode.

16. A method of manufacturing a positive electrode comprising the step of processing an electrode including elemental sulfur under reduced-pressure with the electrode immersed in a non-aqueous electrolyte, thereby impregnating the electrode with the non-aqueous electrolyte.

17. The method of manufacturing a positive electrode according to claim 16, wherein
a pressure during said reduced-pressure process is set to not higher than 28000 Pa.

18. A positive electrode comprising an electrode impregnated with a non-aqueous electrolyte obtained by processing an electrode including elemental sulfur under reduced-pressure with the electrode immersed in a non-aqueous electrolyte.

19. A method of manufacturing a non-aqueous electrolyte secondary battery including the step of preparing a positive electrode by processing an electrode including elemental sulfur under reduced-pressure with the electrode immersed in a non-aqueous electrolyte.

20. A non-aqueous electrolyte secondary battery comprising:
a positive electrode impregnated with a non-aqueous electrolyte obtained by processing an electrode including elemental sulfur under reduced-pressure with the electrode immersed in a non-aqueous electrolyte;
a negative electrode; and
a non-aqueous electrode including a room temperature molten salt having a melting point of not higher than 60° C.

21. The non-aqueous electrolyte secondary battery according to claim 20, wherein
said room temperature molten salt includes a quaternary ammonium salt.

22. The non-aqueous electrolyte secondary battery according to claim 21, wherein
said quaternary ammonium salt includes at least one type selected from the group consisting of trimethylpropylammonium bis(trifluoromethylsulfonyl)imide, trimethylhexylammonium bis(trifluoromethylsulfonyl)imide, and triethylmethylammonium 2,2,2-trifluoro-N-(trifluoromethylsulfonyl)acetamide.

23. The non-aqueous electrolyte secondary battery according to claim 20, wherein
said non-aqueous electrolyte includes at least one type of solvent selected from the group consisting of cyclic ether, chain ether, and fluorinated carbonate.

24. The non-aqueous electrolyte secondary battery according to claim 23, wherein
said cyclic ether includes at least one type selected from the group consisting of 1,3-dioxolane and tetrahydrofuran; said chain ether includes 1,2-dimethoxyethane; and said fluorinated carbonate includes at least one type selected from the group consisting of trifluoropropylene carbonate and tetrafluoropropylene carbonate.

25. The non-aqueous electrolyte secondary battery according to claim 20, wherein
a conductive agent is added to said positive electrode.

26. The non-aqueous electrolyte secondary battery according to claim 20, wherein
said negative electrode includes a carbon material or a silicon material.
